(19) United States
(12) Patent Application Publication
(10) Pub. No.: US 2025/0370417 A1
(43) Pub. Date: Dec. 4, 2025

(54) EQUIPMENT FAILURE IDENTIFICATION AND PREDICTION OF REMAINING USEFUL LIFE USING MACHINE LEARNING

(71) Applicant: Caterpillar Inc., Peoria, IL (US)

(72) Inventor: Daniel J. Reaume, Charlotte, NC (US)

(21) Appl. No.: 18/679,024

(22) Filed: May 30, 2024

(51) Int. Cl. G05B 13/02

(52) U.S. Cl. CPC G05B 13/028

(57) ABSTRACT

Techniques are disclosed herein for machine-learning (ML)-assisted event prediction for industrial machines. Sensor data for an industrial machine can be modified by generating imputed values. A trained neural network can be executed on the modified sensor data to generate classifier tags for the modified sensor data. The system can generate a binding between the sensor data and the classifier, and generate a notification based on the classifier. The notification can relate to or include a predicted failure, anomaly, usage profile, or remaining useful life estimate for the industrial machine. The system can also generate additional training data to improve predictive capacity of the trained neural network. The additional training data can include additional classifiers determined using sensor signaling channel information or sensor data (e.g., using payload values from sensor signals, metadata values from sensor signals, or metadata associated with a particular sensor signaling channel).

### BACKGROUND

The term “industrial equipment” refers to heavy-duty machinery that can be used in manufacturing, construction, or other industrial settings. Industrial equipment can include a wide range of machines, including but not limited to wheel-loaders, skid-steers, dump trucks, excavators, conveyors, generators, forklifts, backhoes, boilers, and other construction-or manufacturing-related equipment. The specific types of equipment will vary depending on the industry and specific operations. Industrial equipment usually needs regular maintenance. For example, regular physical inspections are typically conducted to check for visible signs of wear or damage.

### BRIEF DESCRIPTION OF THE DRAWINGS

Detailed descriptions of implementations of the present invention will be described and explained through the use of the accompanying drawings.

FIG. 1A shows an example telematics ecosystem for monitoring of industrial assets, such as vehicles and machinery.

FIGS. 1B and 1C show schematic representations of aspects of data signals for industrial assets.

FIGS. 1D, 1E, and 1F show example AI/ML-augmented data signals for industrial assets.

FIG. 2 shows an example asset monitoring system for machine-learning based asset monitoring and modeling.

FIG. 3A shows an example implementation of AI/ML subsystems of the asset monitoring system.

FIG. 3B shows an example training schema for the ML models of the AI/ML subsystems of the asset monitoring system.

FIGS. 4A-4J show aspects of example operations performed by the asset monitoring system.

FIG. 5 is a block diagram that illustrates an example of a computer system in which at least some operations described herein can be implemented.

FIG. 6 is a system diagram illustrating an example environment in which the platform operates in some implementations.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Systems and methods are disclosed herein for machine-learning (ML) based event identification and scenario modeling for assets, such as mobile machinery and power generators. The machinery can include or be connected to computing systems that collect sensor data. Sensor signaling channels can transmit information from various on-board or virtual sensors to computing platforms. The information can be used, for example, to monitor operating conditions of a particular machine.

In relation to monitoring a wealth of sensor data generated by industrial machines, it can be difficult to identify actionable sets of data points (e.g., those indicative of outlier operating conditions, equipment or component failure, abnormal operation, and so forth), particularly as machines are deployed and re-deployed under varying operating conditions, which can make previously verified assumptions, insights, and inferences less accurate or even obsolete.

Systems, methods and media disclosed herein can enable ML-assisted failover and relabeling of sensor signaling channels for industrial machines. Sometimes sensor signaling channels can fail (e.g., when communication components fail, when sensors fail) and cease to transmit data or start transmitting inaccurate or incomplete data. In such cases, a trained neural network can be selectively applied to generate a set of sensor value predictions for a particular signaling channel using sensor values from another signaling channel (e.g., when the particular signaling channel is down). Using the predicted values, the system can automatically identify and raise alerts regarding machine operating conditions. A first training dataset, used to initially train the neural network, can relate to a set of condition monitoring sensors on a machine and can include a set of input values associatively linked (e.g., via data bindings) to signaling channel identifiers and/or channel metadata. A second training dataset, generated if a similarity measure between predicted and actual values is under a predetermined threshold, can be used to incrementally retrain the neural network. Channel metadata (e.g., channel configuration information, sensor identifiers, sensor descriptors, asset identifiers, asset types, source addresses, routing addresses) can be modified (e.g., for retraining the neural network) to indicate alternative channels suitable for generating substitute predicted signals for a particular channel.

Additionally, systems, methods and computer-readable media disclosed herein can enable ML-assisted event prediction for industrial machines-for example, by automatically identifying events or conditions using streams of sensor data. The identified events can include machine or component failures, maintenance, productivity events, operating conditions, operator state, and so forth.

In an example implementation, a first set of embeddings can be generated based on first event data, which can be labeled with classifiers determined based on signaling channel information for the first event data. A neural network can be trained, using the classifiers, to generate (i) a similarity score for the first set of embeddings and the second set of embeddings and (ii) a classifier recommendation for the second set of embeddings (where the classifier is representative, at least in part, of an automatically-inferred association between a sensor data stream and a particular, otherwise unknown and undetected, event). The second set of embeddings can be generated based on data collected using condition monitoring sensors for a particular industrial machine. Accordingly, the system can generate alerts, recommendations, and/or notifications based on the automatically classified data encoded in the second set of embeddings.

Incremental training techniques are disclosed for further training the neural network to minimize false positives and/or false negatives. For example, to identify and reduce false positives, channel information can be used to label monitored data, and the known labels can be compared to the labels automatically suggested by the trained neural network. If a discrepancy exists (that is, a particular actual sensor data stream is similar to a data stream used in training but is indicative of a new class or condition not yet learned by the neural network), the neural network can be further trained using labeled data from the actual sensor data stream. To continue the example, to identify and reduce false negatives, channel information can be used to label monitored data, and a level of similarity between actual data and training data can be automatically evaluated. If an actual data stream is labeled (e.g., with a label known to the neural network) but a particular set of sensor values is not yet learned by the neural network, the neural network can be further trained using labeled data from the actual sensor data stream.

In an example implementation, sensor data for an industrial machine can be modified by generating imputed values. A trained neural network can be executed on the modified sensor data to generate classifier tags for the modified sensor data. The system can generate a binding between the sensor data and the classifier, and generate a notification based on the classifier. The notification can relate to or include a predicted failure, anomaly, usage profile, or remaining useful life estimate for the industrial machine. The system can also generate additional training data to improve predictive capacity of the trained neural network. The additional training data can include additional classifiers determined using sensor signaling channel information or sensor data (e.g., using payload values from sensor signals, metadata values from sensor signals, or metadata associated with a particular sensor signaling channel).

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

As used herein, the term “set” refers to a physical or logical collection of objects, which can contain no objects (e.g., a null set, an empty set), one object, or two or more objects. The terms “engine”, “application”, “program”, “circuit” and “executable” refer to one or more sets of computer-executable instructions, in compiled or executable form, that are stored on non-transitory computer-readable media and can be executed by one or more processors to perform software-and/or hardware-based computer operations. The computer-executable instructions can be special-purpose computer-executable instructions to perform a specific set of operations, as defined by parametrized functions, specific configuration settings, special-purpose code, and/or the like. Engines, applications, programs and executables can generate and/or receive various electronic messages.

### Telematics Ecosystem

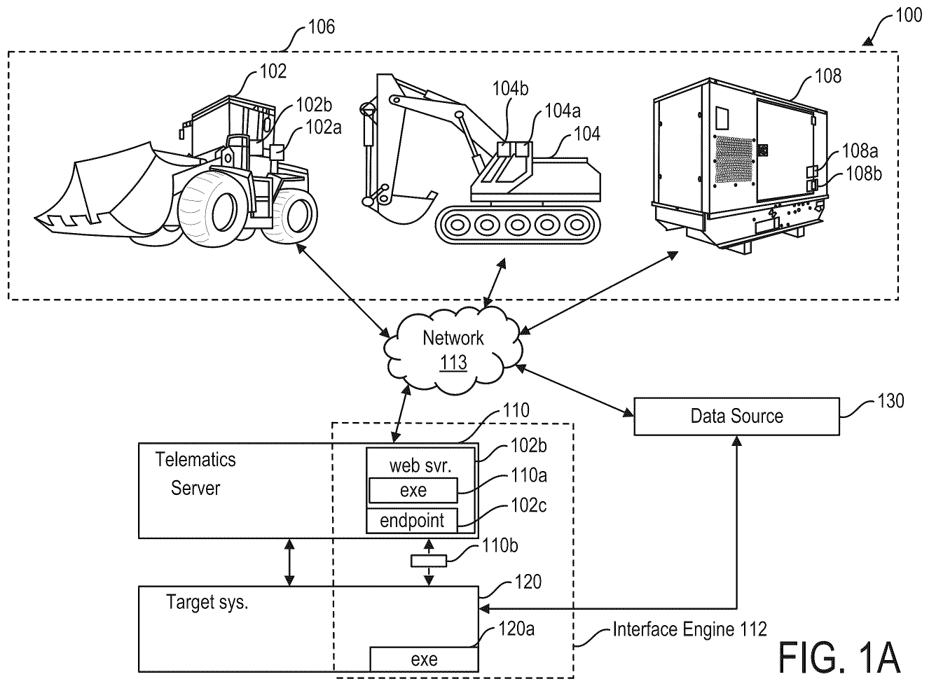

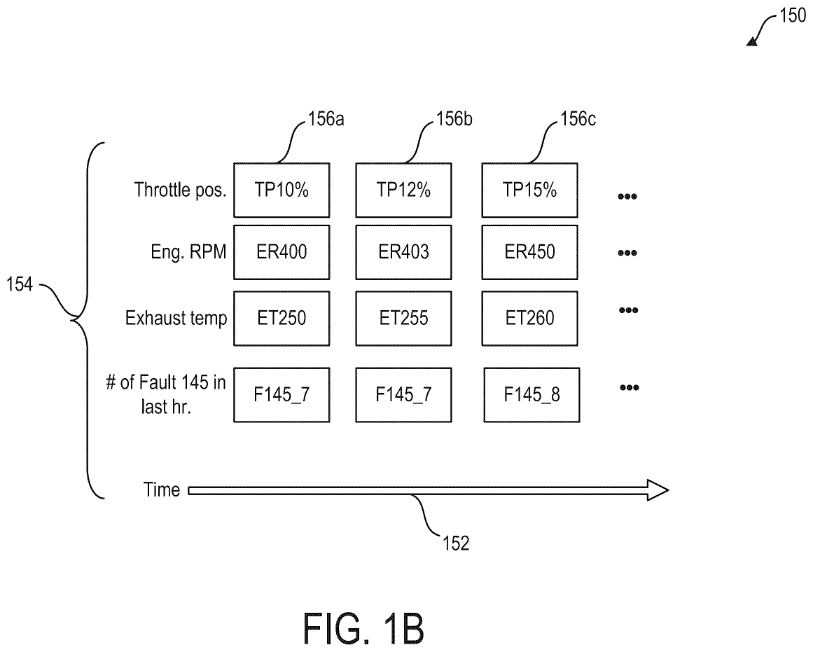

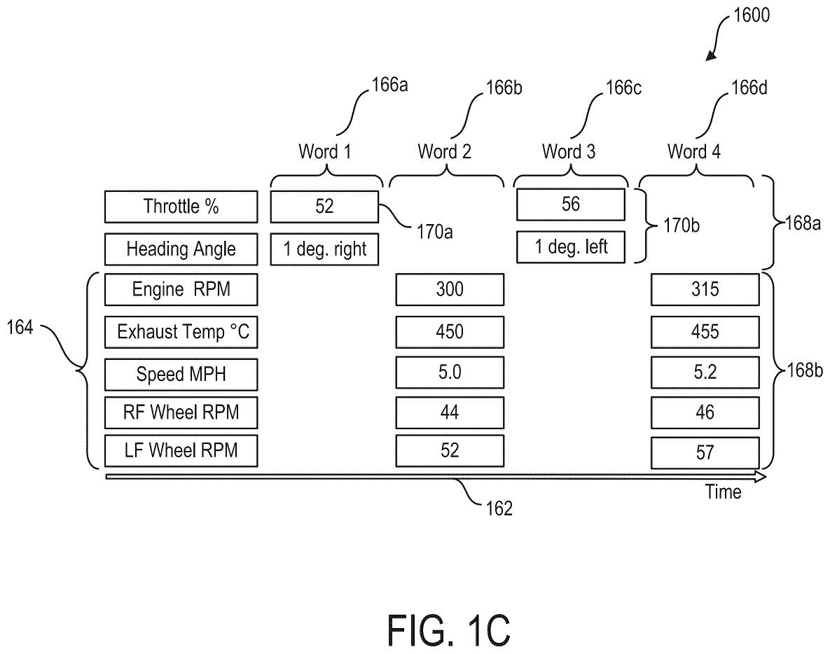

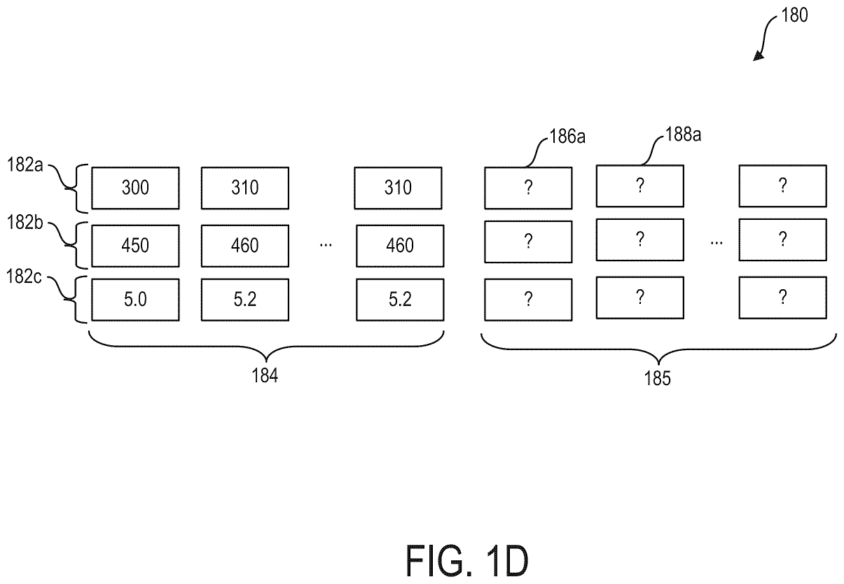

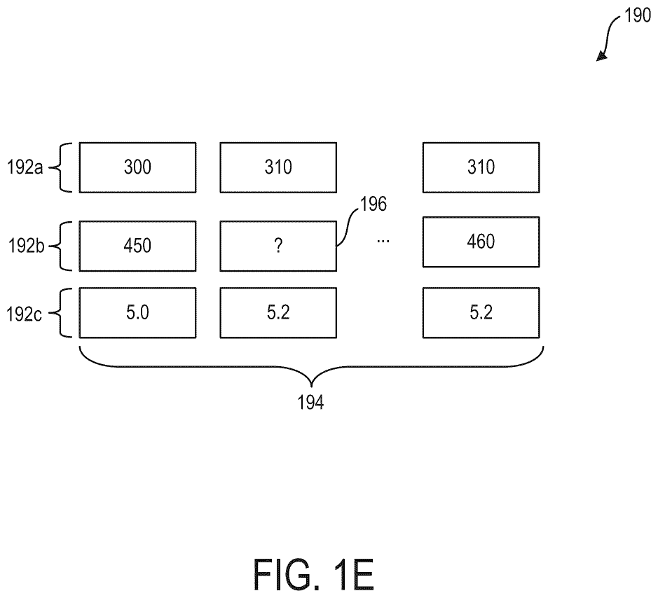

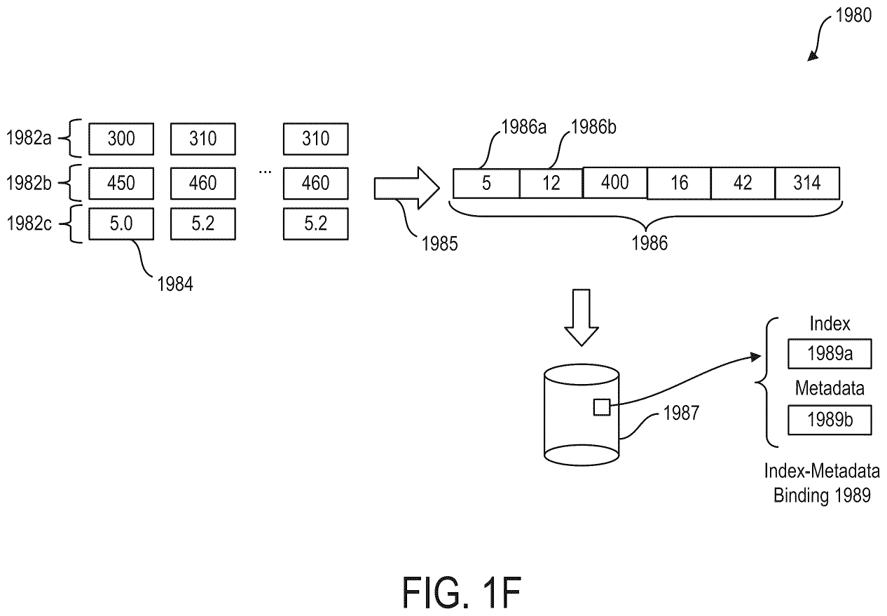

FIG. 1A shows an example telematics ecosystem 100 for monitoring of various assets, such as vehicles, gensets, and machinery. In operation, the one or more assets (102, 104, 108) can generate operating data captured by various sensors (102a, 104a, 108a). The operating data can be transmitted, via the network 113, to one or more telematics servers 110, which can generate API messages 110b to transmit the operating data, in original or modified form, to various target computing system(s) 120. The target computing system(s) 120 can use the received data as training data (e.g., for AI/ML systems), for analytics relating to operating conditions of the assets (102, 104, 108) and so forth.

One or more types of assets (102, 104, 108) can be included in a particular fleet 106. The assets (102, 104, 108) in the particular fleet 106 can be associated with one or more original equipment manufacturers (OEM). The assets (102, 104, 108) can include various mobile machinery items, such as earth moving machinery, mobile construction machinery and so forth, which perform various tasks, such as excavation, loading, transportation, drilling, spreading, compacting, and/or trenching of earth, rock and other materials and can be deployed for work on roads, in quarries, in mines and so forth. Accordingly, the assets (102, 104, 108) can include dozers, loaders (swing loaders, skid-steer loaders, backhoe loaders, and so forth), excavators, trenchers, dumpers, scrapers, graders, landfill compactors, rollers, pipelayers, drills, tool carriers, drainage pipe layers, ploughs, mixers (e.g., concrete mixers) and so forth. The assets (102, 104, 108) can be individual machines or combinations of devices (e.g., combinations of base machines and equipment or attachments, such as augers, buckets, blades, tillers, forks, rakes, trenchers, shears, compactors, pulverizers, and so forth) where the combinations can be identified by a product identification number (PIN), machine serial number, or another identifier. According to various implementations, the assets (102, 104, 108) can be direct-controlled devices (e.g., devices controlled by an operator in physical contact with the device) and/or self-propelled devices. The assets (102, 104, 108) can be ride-on devices, non-riding direct-controlled devices, non-riding remote controlled devices, mobile remote-controlled devices, and so forth. The assets (102, 104, 108) can further include generators or gensets (generator sets, which can include engines that drive generators that can provide power used to run other equipment). The assets (102, 104, 108) can be wire-controlled and/or wireless-controlled.

Assets (102, 104, 108) generate and report various items of information. To generate and report the information, assets (102, 104, 108) can each include a set of sensors (102a, 104a, 108a) and a set of controllers (102b, 104b, 108b). The sensors (102a, 104a, 108a) are configured to enable monitoring a variety of operating conditions, including real-time operating conditions of the assets (102, 104, 108) and real-time operating conditions for asset components (e.g., engine, attachments, surroundings, operating environment and so forth). The sensors (102a, 104a, 108a) can collect operating data, which is transmitted by the controllers (102b, 104b, 108b), via the network 113, to one or more telematics servers 110. The network 113 can operate according to one or more wired or wireless protocols, such as Wi-Fi, cellular, radio, satellite, Bluetooth, ZigBee, etc. To enable transmission of data and traffic management, the network 113 can include connectivity equipment, such as modems, Bluetooth transceivers, Bluetooth beacons, RFID transceivers, NFC transmitters, and the like. In some implementations, the network 113 can include a controller area network (CAN) of a particular asset (102, 104, 108).

The sensors (102a, 104a, 108a) can provide analog readings and/or digital readings. The information provided by the sensors can be used to perform on-board and/or remote diagnostics of the assets (102, 104, 108) and can relate to various operating parameters of the assets (102, 104, 108). According to various implementations, the sensors (102a, 104a, 108a) can include radar components, lidar components, cameras, ultrasonic devices, GPSs (global positioning systems) and/or other suitable components. The sensors can include components that provide two-dimensional (2D) or three-dimensional (3D) maps, readings, or information. For example, a sensor can include a camera capable of capturing light and/or other electromagnetic radiation through pixels (e.g., as in the case of a charge-couple device (CCD)). For example, a sensor can include a 2D arrangement of pixels (e.g., “cells”), each of which is capable of recording one or more signals (e.g., associated with photons of a particular range of wavelengths). In some implementations, the assets can include multiple such sensors, thereby enabling the signal evaluation platform to generate a 3D mapping of objects in the vicinity of the assets. In some implementations, sensors (102a, 104a, 108a) can provide on-demand and/or periodic readings regarding engine-out exhaust gas temperature, NOx levels, speed, engine torque, asset (102, 104, 108) positioning, temperature (e.g., coolant temperature, intake air temperature, exhaust gas temperature), oil pressure, tire pressure, load measurement, fuel consumption, and so forth. The sensors (102a, 104a, 108a) can also provide indications of operator engagement with or actuation (including automatic/autonomous actuation) of various components of the asset (102, 104, 108), such as steering wheel, attachment positioning levers, acceleration pedals, and so forth. Gensets 108 can include sensors 108a that can provide measures of power output, such as voltage, amperage, and/or real power output (measured in kilowatts (kW) per hour).

The controllers (102b, 104b, 108b) can activate, operate, and/or control sensors (102a, 104a, 108a), fuse the readings of multiple sensors (102a, 104a, 108a), convert analog values to digital values, generate electronic messages containing sensor readings, and/or transmit sensor readings, via the network 113, to one or more telematics servers 110. The controllers (102b, 104b, 108b) can include hardware and/or software circuitry and can be associated with particular components of assets (102, 104, 108). For instance, controllers (102b, 104b, 108b) can include engine control units (ECUs) that control engine operations. In other examples, controllers (102b, 104b, 108b) can include powertrain control modules (PCMs), brake control modules (BCMs), door control units (DCUs), speed control units (SCUs), transmission control modules (TCMs), battery management systems (BCMs), telematics control units (TCUs), and so forth.

An example controller (102b, 104b, 108b) can be an electronic controller. The elements of an electronic controller (102b, 104b, 108b) can include, for instance, a processor/microcontroller, memory (e.g., SRAM, EEPROM, Flash), input devices (supply voltage and ground, digital input devices, analog input devices), output devices (actuator drivers, such as injectors, relays, valves), logic outputs, communication circuitry and equipment (CAN transceivers, Ethernet transceivers, including wired and wireless communication components), and various embedded software modules (boot loaders, metadata, configuration data). Accordingly, in some implementations, controllers (102b, 104b, 108b) can be structurally and/or communicatively integrated with sensors (102a, 104a, 108a). For instance, in an example where a particular controller (102b, 104b, 108b) is a TCU structured to collect, pre-process, and/or transmit telematics data, the controller (102b, 104b, 108b) can include a navigation unit (sensor (102a, 104a, 108a) that keeps track of the latitude and longitude of the asset (102, 104, 108)), a mobile communication transceiver (e.g., GSM, GPRS, Wi-Fi, WiMax, LTE or 5G), a memory, a processor, and/or a battery module and/or another power source (e.g., an interface to the power system of the asset (102, 104, 108)).

In telematics, edge computing techniques can offer a technical advantage of offloading complex processing tasks to edge computing systems in networks of computing systems, where the edge computing systems can pre-process sensor data for transmission to other nodes. Edge computing techniques can reduce the size of data transmissions and optimize network traffic. More specifically, edge computing techniques can optimize the use of transmission media bandwidth, increase the informational value of transmitted data, and/or increase the overall information throughput on a particular network. To that end, controllers (102b, 104b, 108b) can include edge computing features and can pre-process data from sensors (102a, 104a, 108a) by, for example, generating data averages, discarding data outliers, discarding repeated sensor data via periodic sampling, and so forth. In some implementations, the controllers (102b, 104b, 108b) can provide raw sensor data to the telematics server 110, which can perform edge computing operations by the executable 110a prior to transmitting the sensor data to the target computing system(s) 120. In some implementations, the controllers (102b, 104b, 108b) are integrated with the telematics server 110. For example, the controllers (102b, 104b, 108b) can include the executable 110a, and/or multiple executables 110a can be distributed across a particular controller (102b, 104b, 108b) and telematics server 110. In some implementations, the operations described herein can be performed, in whole or in part, at the controllers (102b, 104b, 108b).

In some implementations, the telematics server 110 can perform additional (e.g., increased-complexity) edge operations, such as generating virtual sensor values using information provided by multiple types of sensors (102a, 104a, 108a).

The executable 110a at the telematics server 110 can include a fusion engine that can combine information from various sensors. For example, the executable 110a can combine raw reflection data from lidar, radar, and/or ultrasonic sensors (102a, 104a, 108a) with raw frame data from camera sensors (102a, 104a, 108a) and/or additional data to more accurately estimate a distance from a particular surface point on the asset (102, 104, 108) or its attachment to the object photographed by the camera. In some examples, the additional data can be collected by a set of inertial movement unit (IMU) sensors (102a, 104a, 108a) and can include, for example, multi-axial acceleration data collected via accelerometer(s) of the IMU and/or multi-axial velocity data collected via gyroscope(s) of the IMU. In some examples, the additional data can include multi-axial translational movement data (surge, heave, sway), multi-axial rotational movement data (roll, pitch, yaw) and so forth. The sensors (102a, 104a, 108a) can be mounted at suitable surface points or joints of assets (102, 104, 108) or attachments to enable collection of these types of data. As another example, the executable 110a can utilize generator 108 raw data (voltage, amperage) and/or lookup tables (e.g., power rating) to calculate power output in kilowatts per unit of time.

In some implementations, instead of or in addition to performing edge operations, the telematics server 110 can collect, via the controller (102b, 104b, 108b), raw or preprocessed sensor readings. Using raw or preprocessed sensor (102a, 104a, 108a) data, the telematics server 110 can generate electronic API messages 110b and transmit the electronic API messages 110b to target computing system(s) 120.

The target computing system(s) 120 can include various executables 120a structured to enable management and analytics of data about the assets (102, 104, 108). For example, the executables 120a can enable sensor monitoring, safety monitoring, real-time or substantially real-time communication, detection of operating conditions, monitoring of mileage, monitoring of fuel consumption, monitoring of weather conditions, wear and tear monitoring, load monitoring and so forth. An example of a target computing system is the asset monitoring system 200 described further herein.

In some implementations, the target computing systems 120 can include AI/ML engines, which can be trained to generate predictions based on the input data received, in the form of API messages 110b and/or from other systems, by the target computing system(s) 120. For example, AI/ML models of the AI/ML engines can be trained to generate predictions for fuel consumption levels based on the data that includes asset model identification, asset type, asset attachment identification, asset application/use and duration, and/or asset fuel consumption for particular time periods (hourly, daily, and so forth). As another example, the AI/ML applications can be trained to generate simulations that enable digital twin operations, including, for example, operating condition prediction, object position prediction, and/or prediction of values and operating scenarios using other operating parameters of a particular asset (102, 104, 108) or fleet 106.

The executables 120a use specific types of data to perform their intended tasks. Therefore, the API messages 110b can include sensor data and/or additional data that augments or supplements the sensor data. For example, the API messages 110b (or data collected by the target computing system(s) 120 through other channels) can include service records for assets (102, 104, 108), complaint, defect, and/or recall records for assets (102, 104, 108), part replacement history for assets (102, 104, 108) including part identifiers, and so forth. In some implementations, the target computing system(s) 120 can receive, via API messages 110b or otherwise, additional data, such as weather condition data, road traffic monitoring data, road condition monitoring data, elevation data, location data, map data, and so forth. The additional data can be retrieved (e.g., in an API call, through a query, through a dataset or file importation process) or received (e.g., in a targeted or broadcast message) from one or more additional data sources 130.

The API messages 110b can be generated by the interface engine 112, which can include one or more web servers/web services engines, one or more endpoints 102c, and/or one or more executables (110a, 120a). The API messages 110b can be structured according to a standard (e.g., ISO-15143 or similar) that enables computing systems to exchange telematics data. The API messages 110b can include collections of addressable data elements, which can be structured as delimited records (e.g., comma-delimited, semicolon-delimited, space-delimited, and so forth), key-value pairs or nested key-value pairs (e.g., .json), labeled or tagged data or nested labeled/tagged data (e.g., .xml), and/or tabular data (e.g., SQL datasets, Excel datasets, and so forth).

In some implementations, executables 120a at target computing system(s) 120 can obtain, update and/or otherwise interact with the data resources in the API messages 110b by causing computer-executable commands to be executed and transmitted via a communication channel, such as http, https, and so forth. Accordingly, the telematics server 110, target computing system 120, and/or computing systems described further herein can be identified by a uniform resource locator (URL), and the computer-executable commands can include http operations, such as post (i.e., to create an item at the specified destination), get (i.e. to read an item from a specified destination), put or patch (i.e. to update a portion of an item in the specified destination), and/or delete (i.e. to delete an item in a specified destination).

A particular API message 110b can include the attributes sufficient to generate a particular unit of information about the asset (102, 104, 108). The units of information can be provided by a set of corresponding API endpoints 102c (digital locations where the interface engine 112 receives requests for specific resources) at the web server. Example units of information, also referred to as API resources, can include snapshot information (e.g., fleet snapshot, equipment status snapshot) and/or time series information (e.g., fault code time series, attachment status time series, sensor image time series).

Fault code time series can include items such as fault code identifier, description, severity, source system, reported date/time and so forth. Location time series can include items such as latitude, longitude, altitude, date/time and so forth. Switch status time series, attachment status time series, and/or engine condition time series can include items such as asset on/off status, part number (e.g., engine number, switch number, attachment part identifier), date time, and so forth. The operating hours time series, idle operating hours time series, fuel used time series, and/or remaining fuel time series can include items such as value, date/time and so forth. Various additional time series data, such as distance, fuel remaining (e.g., value, percentage), diesel exhaust fluid remaining (e.g., value, percentage) and so forth can be included.

The snapshot information messages can include cumulative and/or point-in-time data for any of the above time series data items for a particular asset (102, 104, 108) or a fleet 106 of assets (102, 104, 108). An example fleet snapshot can include information for a set of assets (102, 104, 108) in a particular fleet 106. A fleet snapshot message 110b can include, for example, header information containing a fleet identifier, asset identifiers, and/or asset information (OEM, model, equipment type, equipment identifier, serial number and so forth). An asset snapshot message 110b can include, for example, header information including asset information.

Various communication arrangements are contemplated herein. For example, in some implementations, the telematics server 110 and/or the web server 102b of the telematics server 110 can be bypassed, and the target system 120 can receive electronic messages directly from the asset (102, 104, 108). For example, the target system 120 can include a diagnostic and/or monitoring application that can be communicatively coupled to components of the asset (e.g., ECU, CAN, other asset controllers, asset sensors). As another example, the telematics server 110 and/or the web server 102b of the telematics server 110 can be bypassed when the target system 120 obtains additional data from the additional data source 130, and the target system 120 can communicate directly with the additional data source 130. As yet another example, the target system 120 can be one of a plurality of target systems, where each target system is configured to receive information from a particular fleet 106 or a subset of assets in a fleet 106 (e.g., where the target systems 120 are associated with specific dealers for a particular OEM). As yet another example, the target system 120 can be configured to receive and process data from a plurality of telematics servers 110 or assets in fleets 106 (e.g., where the target system 120 is maintained by an entity other than a particular OEM and/or can accommodate data from a plurality of OEMs).

### Asset Data Signaling

FIGS. 1B and 1C show example representations of whole or partial data signals for industrial assets. The data signals can be generated using various sensors (102a, 104a, 108a) of the assets (102, 104, 108). The data signals can include, for example, API messages 110b and/or electronic signals communicated from various components (e.g., ECU, CAN, other asset controllers, asset sensors) of the asset (102, 104, 108) to the target applications without involving the API messaging infrastructure. The data signals can include payload (e.g., items from which the sensor values can be extracted or decoded) and metadata (e.g., signal address information, signal routing information, signal control information, signal sequencing information).

Signal payload and/or metadata can include items that can be useful in training the AI/ML models described herein. For example, the items can include sensor network identifiers, serial number identifiers, asset identifiers, sensor identifiers, channel identifiers, location identifiers, and so forth. These items can be transformed (e.g., rolled up, aggregated, or otherwise classified to match a particular determined asset type, sensor network type, sensor manufacturing series, sensor or asset location) by using segments of the payload or metadata values. The transformed items can be utilized to label sets of sensor data and/or sensor signal channels in model training. Labeling of sets of sensor data and/or sensor signal channels in model training can enable technical advantages, including improving predictive accuracy of the models through incremental training and retraining iterations. For example, a base model trained on asset data can be fine-tuned by being iteratively trained on additional data. The additional data can include modified data. The modified data can include sensor or channel data that is automatically labeled (for example, by determining a segment and cross-referencing a database or a table that provides a roll-up or category for the segment). The modified sensor or channel data can include, for example, asset type data, sensor network, and/or asset identifier (serial number) data.

As described in relation to FIG. 1A, assets (102, 104, 108) can capture and/or generate a wealth of data, including data 154, such as sensor data and/or user data. Table 150 shows example data items (156a, 156b, 156c), which can be encoded or otherwise included in sensor signals (for example, included in the payload portion of sensor signals). As shown in table 150, the data signals can include time-series data, where a particular data item (156a, 156b, 156c) represents a point-in-time reported value on timeline 152. The point-in-time values can be reported, using the sensors, as-needed or periodically (e.g., every second, every 5 seconds, every 60 seconds, every 5 minutes, every 60 minutes, daily, weekly, and/or monthly). In some implementations, the point-in-time values can be pooled (e.g., by the controllers (102b, 104b, 106b)) and periodically transmitted to the target systems.

As described in relation to FIG. 1B, data items (166a, 166b, 166c, 166d) in data 164 can be user-generated or system-generated. In some implementations, user-generated and system-generated items data be received in separate datasets or in separate data streams or channels. In some implementations, the user-generated and system-generated data are combined. The user-generated data 168a can include readings/values captured based on operator interaction with the asset (102, 104, 108). Examples of user-generated data 168a include throttle percentage, heading angle, and/or various additional control settings and positions for mechanical, electrical, or electronic operating controls of the asset (102, 104, 108). The operating controls can include on-board controls and/or off-board controls (for example, controls that are communicatively coupled to the asset in wired or wireless form). The operating controls can include levers, buttons, steering controls, settings set by operators via on-board or off-board control panels, and so forth. The system-generated data 168b can include readings/values captured based on operation of various other components of the asset (102, 104, 108).

The point-in-time values represented by data items (156a, 156b, 156c) can be instrumental in generating sensor value predictions, imputations, and/or embeddings. Additionally, the point-in-time values represented by data items (156a, 156b, 156c) can be instrumental in generating synthetic data items and/or inferences about other data items or data streams. For example, the user-generated data 168a, combined with system-generated data 168b, can enable predictions, imputations, and/or inferences regarding operation of the asset (102, 104, 108). The predictions, imputations, and/or inferences can be facilitated by conceptualizing individual data items 170a or aggregations 170b of data items (e.g., min, max, count, roll-up, average) as terms (words, tokens) in a language. Accordingly, the values of the data items 170a or aggregations 170b of data items can, individually or in combination, offer insight into the operating condition of the asset. Furthermore, semantic value of the data items 170a or aggregations 170b of data items can be enhanced by considering these terms in relation to one another. For instance, techniques such as cosine similarity can be utilized to identify patterns in groups of sensor values.

### AI/ML-Assisted Augmentation of Asset Data Signals

FIGS. 1D, 1E, and 1F show example AI/ML-augmented data signals for industrial assets. According to various implementations, the platform described herein enables generation of predictions, imputations, and/or embeddings based on the data signals described above. In some implementations, the predictions, imputations, and/or embeddings can be generated on a per-channel basis. A particular signaling channel (e.g., stream of API messages 110b) can be configured to transmit sequences of sensor messages for a particular sensor and asset combination, sensor type and asset combination, sensor across a set of assets (e.g., in a particular geographical location), and/or sensor type across a set of assets. The sensor type can be determined, for example, based on the type of the API message 110b, based on the function of the sensor (temperature, pressure, etc.), based on a component of the asset (e.g., engine, chassis), or based on a combination thereof. The signaling channel can include software (e.g., programmable circuits) and/or hardware components (processors, memory, routers) that enable generation and/or transmission of electronic messages for components of FIG. 1A. Signaling channels can include components disposed at or operable across devices, such as components built into or communicatively coupled to assets (102, 104, 108), target computing systems, and/or computing systems for remotely controlling assets (e.g., where controllers (102b, 104b, 108b) of the assets (102, 104, 108) cause the assets to perform operations based on instructions from off-board computing systems).

To illustrate a sensor value prediction scenario, FIG. 1D shows an augmented data set 180, which includes a source data subset 184 and a predicted data subset 185. In an example scenario, a set of sensor values can be received via a set of channels. For example, values for a first particular sensor can be received via the first channel 182a, values for a second particular sensor can be received via the second channel 182b, and values for a third particular sensor can be received via the third channel 182c. The sensors can be of the same type or different types, and can be coupled to the same asset, different assets of the same type, or different assets of more than one type. The source data subset 184 can include raw (extracted) or transformed (e.g., averaged, combined, aggregated, imputed) sensor values. Based on the source values, a trained machine learning model (e.g., a neural network, such as an autoencoder, a large language model (LLM), a classifier model) can generate the predicted data subset 185, which can include predicted data points (186a, 188a). In some implementations, the predicted data subset 185 includes continuations of the time-series data (e.g., predictions of sensor values in a particular channel for the next 10 minutes, predictions of the next 10 sensor values in a particular channel, and so forth).

To illustrate a sensor value imputation scenario, FIG. 1E shows an augmented data set 190, which includes a data subset 194 having a set of source values and a set of imputed values 196. In an example scenario, the set of source values can be received via a set of channels. For example, values for a first particular sensor can be received via the first channel 192a, values for a second particular sensor can be received via the second channel 192b, and values for a third particular sensor can be received via the third channel 192c. The sensors can be of the same type or different types, and can be coupled to the same asset, different assets of the same type, or different assets of more than one type. The source values can include raw (extracted) or transformed (e.g., averaged, combined, aggregated, imputed) sensor values. Based on the source values, a trained machine learning model (e.g., a neural network, such as an autoencoder, an LLM, a recurrent neural network, a regression-based model) can generate the set of imputed values 196. In various implementations, the set of imputed values 196 includes estimates of missing values of the time-series data, replacement values for detected and discarded outlier values, and so forth. Imputed values can be generated to improve data quality for training data sets with incomplete data, enhance the data by cross-referencing values to ontologies, or compensate for data discontinuities in a time series (for example, to compensate for data discontinuities due to sensor failover in a particular channel).

Another technique in AI/ML-assisted augmentation of signals can include comparing sets of signals to identify patterns and/or detect similarities. Sets of sensor values for one or more channels can be augmented with additional information, such as geographical coordinates, categorical labels that represent asset types, source identifiers, and so forth. Additionally, some sensors can generate unstructured data, such as text (e.g., fault codes and descriptions) and/or images (e.g., obstacle sensors, navigation applications). Mixed-type data can be difficult to correlate and interpret. To solve this problem, sensor values can be vectorized-that is, embeddings can be generated using the data.

To illustrate, FIG. 1F shows a set of embeddings 1986 (augmented data set), which can be generated, at 1985 (for example, by the feature generator engine 224) using a data subset 1984. The data subset 1984 can include source values, predicted values, and/or synthetic (modified, transformed) values. In an example scenario, the set of values can be received via a set of channels. For example, values for a first particular sensor can be received via the first channel 1982a, values for a second particular sensor can be received via the second channel 1982b, and values for a third particular sensor can be received via the third channel 1982c. The sensors can be of the same type or different types, and can be coupled to the same asset, different assets of the same type, or different assets of more than one type. The source values can include raw (extracted) or transformed (e.g., averaged, combined, aggregated, imputed) sensor values. In some implementations, the transformed sensor values are associated with an automatically-generated label, which contextualizes a source of the data (e.g., sensor identifier, sensor descriptor, a descriptor of the measured value, a channel descriptor, an asset type, an asset descriptor, and so forth). To automatically generate the label, the relevant items (e.g., sensor identifier, sensor descriptor, a descriptor of the measured value, a channel descriptor, an asset type, an asset descriptor, and so forth) can be parsed from the data itself (payload items), metadata associated with the payload, and/or channel information.

Based on the source values, the feature generator engine 224 can generate one or more sets of embeddings 1986. An embedding (1986a, 1986b) is a learned numerical representation (such as, for example, a vector) of a token that captures some semantic meaning of the data item (e.g., a data item from the data subset 1984) represented by the token. The embedding (1986a, 1986b) represents the segment corresponding to the token in a way such that embeddings (1986a, 1986b) corresponding to semantically related segments are closer to each other in a vector space than embeddings corresponding to semantically unrelated segments. For example, assuming that the words “throttle percentage,” “heading angle,” and “ambient temperature” each correspond to, respectively, a “throttle percentage” token, a “heading angle” token, and an “ambient temperature” token when tokenized (extracted from the labels or data streams), the embedding (1986a, 1986b) corresponding to the “throttle percentage” token will be closer to another embedding corresponding to the “heading angle” token in the vector space as compared to the distance between the embedding (1986a, 1986b) corresponding to the “throttle percentage” token and another embedding corresponding to the “ambient temperature” token.

The vector space can be defined by the dimensions and values of the embedding vectors. Various techniques can be used to convert a token to an embedding (1986a, 1986b). For example, the feature generator engine 224 can parse the data and/or automatically generated labels out of the input data streams. In some implementations, the feature generator engine 224 can pre-process the data. Pre-processing techniques can include generating data averages or other aggregations across neighboring sets of N values (2, 3, 5, 10) in a data stream, generating data averages or other aggregations across channels for data values receive in a particular window of time M (e.g., within a 5-min. time window), generating or associating text descriptors with image data, parsing or generating labels, and so forth.

After pre-processing the data, the feature generator engine 224 can provide the pre-processed data to a vectorization executable (by, for example, parametrizing and invoking the executable). The vectorization executable can include a transformer neural network. The parameters for vectorization operations can include encoding format (e.g., float, int, double, base64), maximum number of dimensions, user identifiers, and so forth. The vectorization executable can use a suitable vectorization technique to generate and return a set of embeddings 1986, which can include vectorized representations of the pre-processed data. The set of embeddings can be structured as an array, list, collection, memory block, dataset, tabular data file, or in another suitable format. According to various implementations, the embeddings executable can maintain the set of embeddings in memory (e.g., cache), on disk, or both.

The feature generator engine 224 can store the sets of generated embeddings 1986 in vector database 1987. The feature generator engine 224 can generate (or cause the vector database 1987 to generate) various optimizations for the sets of embeddings. The optimizations can include indexes 1989a. In this context, the term “index” can refer to an organizational unit of vector data, where a vector includes a particular set of embeddings. An index can have various properties, such as a maximum number of dimensions, maximum number of vectors and so forth. In some implementations, the feature generator engine 224 can bind, to vectors, metadata extracted, for example, in the course of automatically generating sensor data. The metadata can be used to filter index records when they are queried. For example, sensor identifiers, sensor descriptors, descriptors of the measured values, channel descriptors, asset types, and/or asset descriptors can be included in vector metadata and used to dynamically limit vector searches to relevant data. In some implementations, indexes 1989a can be further optimized in the vector database 1987 to accommodate aspects of sensor data streams or channels. For example, indexes can be dynamically partitioned into sections (e.g., namespaces) that can correspond to various logical or organizational units within the data subsets 1984 (e.g., topics, asset types, asset components, channels, sets of channels, channel types across assets, channel types for an asset). Partitioning enables the technical advantage of automatically limiting data sets returned by queries to relevant items. Metadata 1989b can include additional information extracted from the parameters, such as access control information for the embeddings, channel identifiers, and so forth.

An embeddings retrieval pipeline (e.g., model execution engine 228, actuator/recommender engine 230) can access vectorized data stored in vector database 1987. To facilitate similarity measurement operations on vectors stored in the vector database 1987, a suitable distance metric can be applied to vectorized data. For example, distance metrics for semantic similarity searches can include Euclidian distances, cosine similarity scores, and/or dot-product scores. In some implementations, distance metrics can be selected or determined based on the type of stored data, the type of query, and so forth. The query results can be provided to the requestor entity/application (e.g., via a GUI, via an API), such as the program 212.

The generated embeddings 1986 in vector database 1987 can constitute, comprise, or be included in feature maps used as training data and/or as inputs to the trained AI/ML models described herein. In some scenarios, the terms vector and feature map are used interchangeably. In some implementations, a feature map can include a set of indexes 1989a. In some implementations, a feature map can include a set of indexes 1989a and their associated metadata 1989b. In some implementations, a feature map can include certain values/embeddings extracted from the vectors. In some implementations, a feature map can include raw or augmented of the data subsets described herein (e.g., raw or augmented sensor values, labels, channel information, asset information, and so forth). The feature maps can be structured in any suitable form, such as vectors, tables (e.g., relationally-linked tables), records, datasets, key-value pairs, markup language structures (e.g., HTML, XML), arrays, variables, parameter values, pointers, and so forth.

### Asset Monitoring System

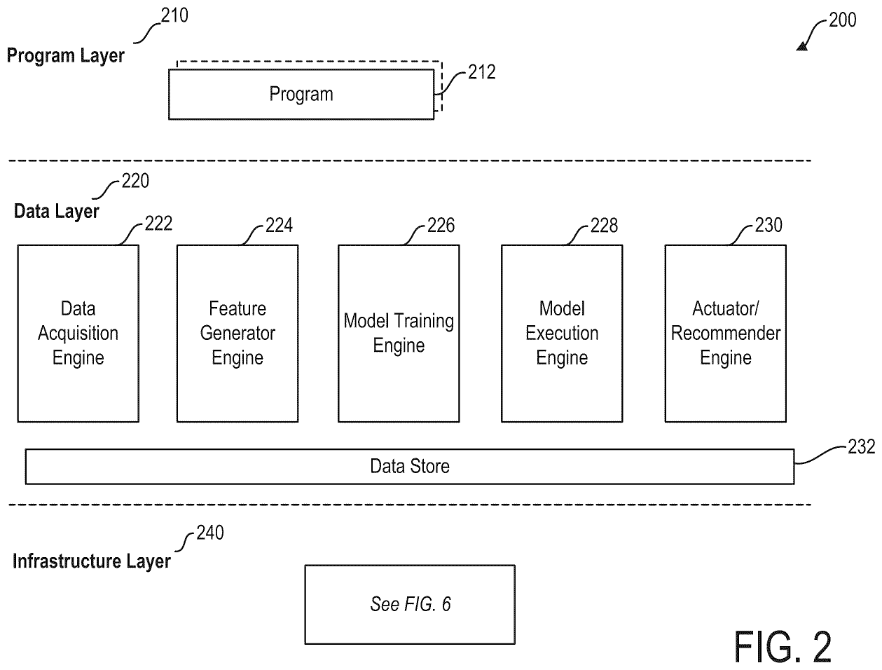

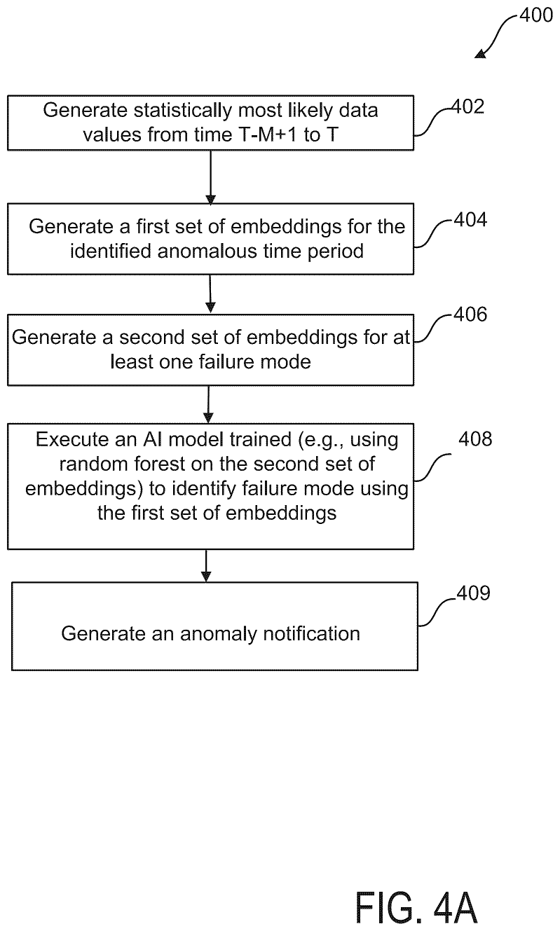

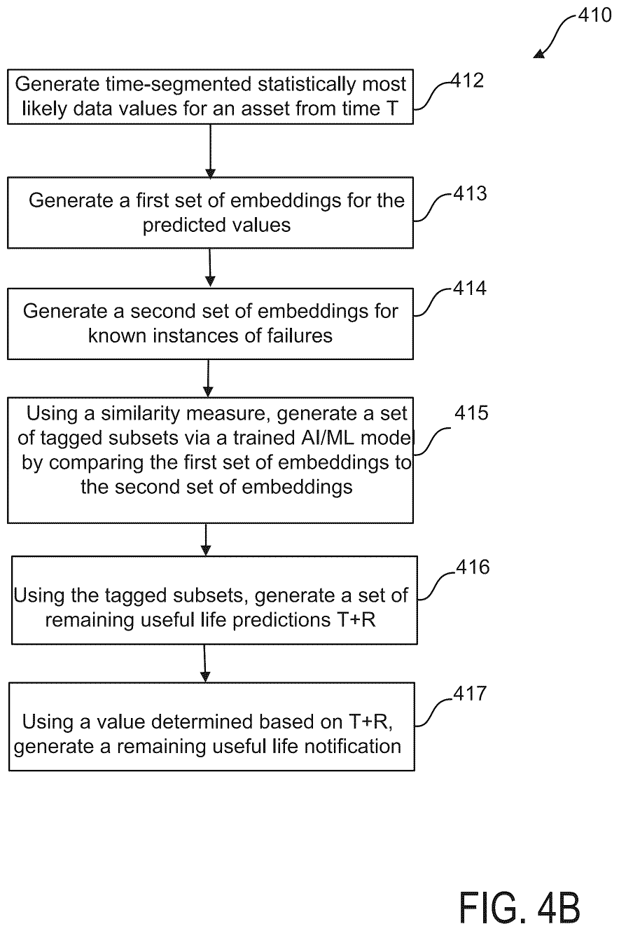

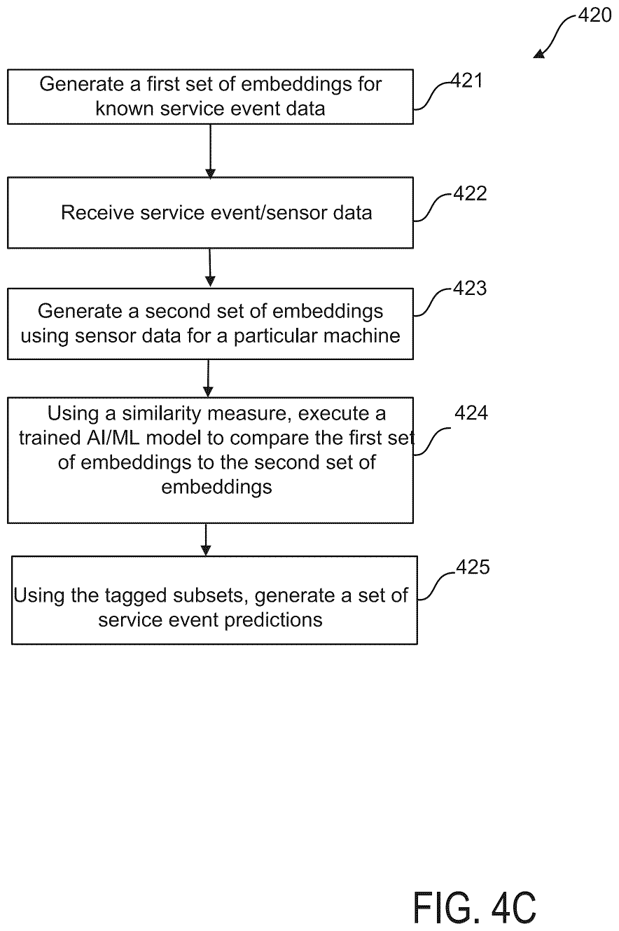

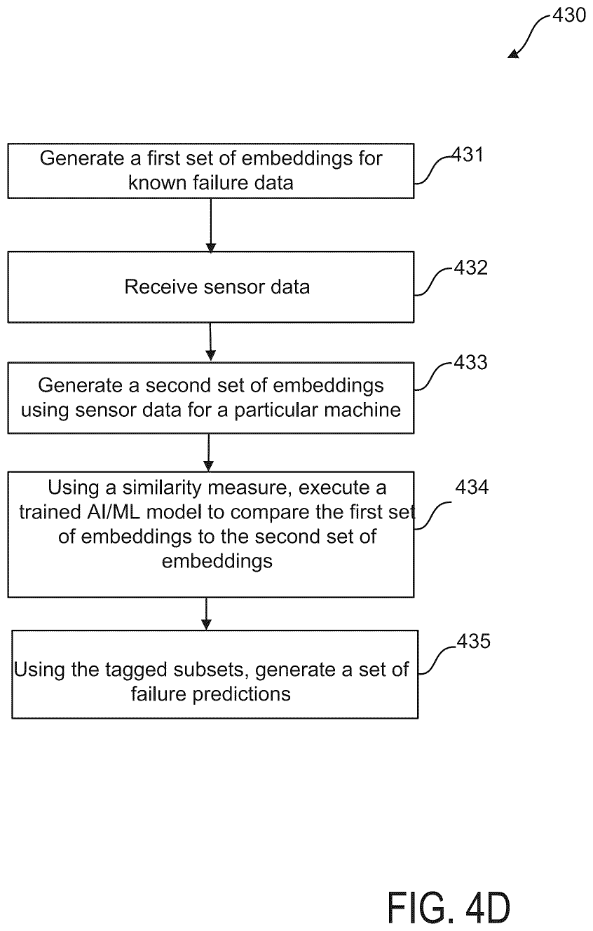

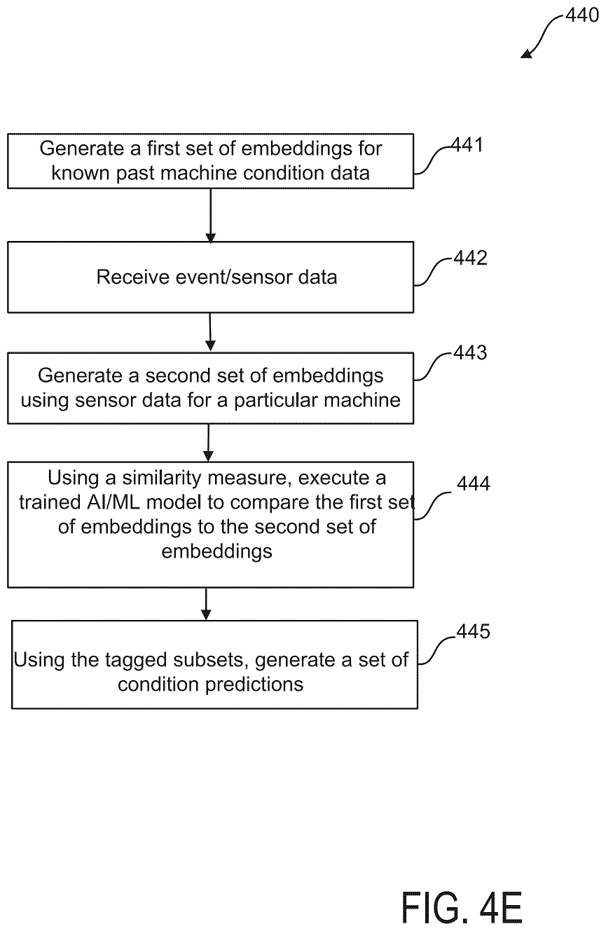

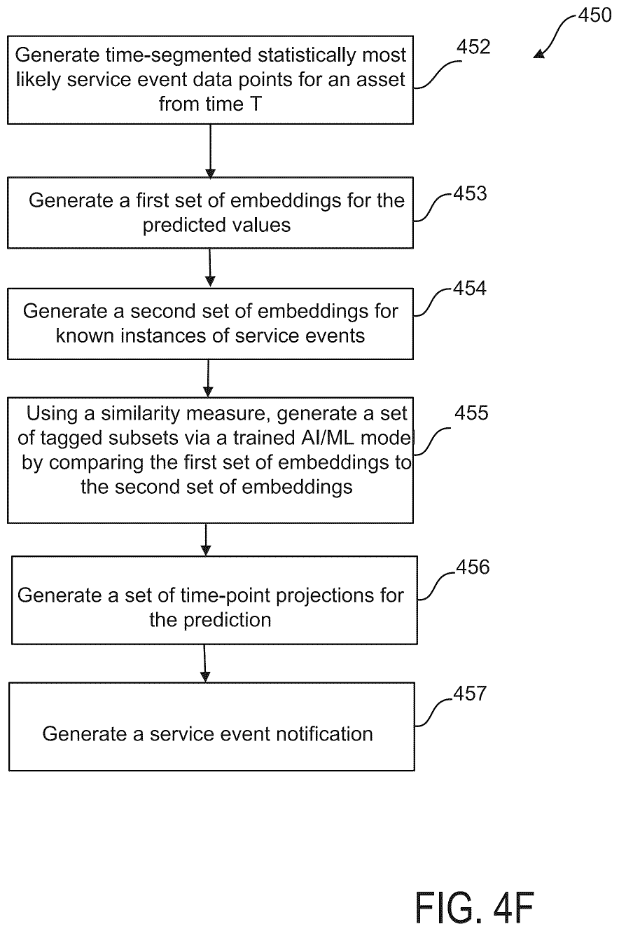

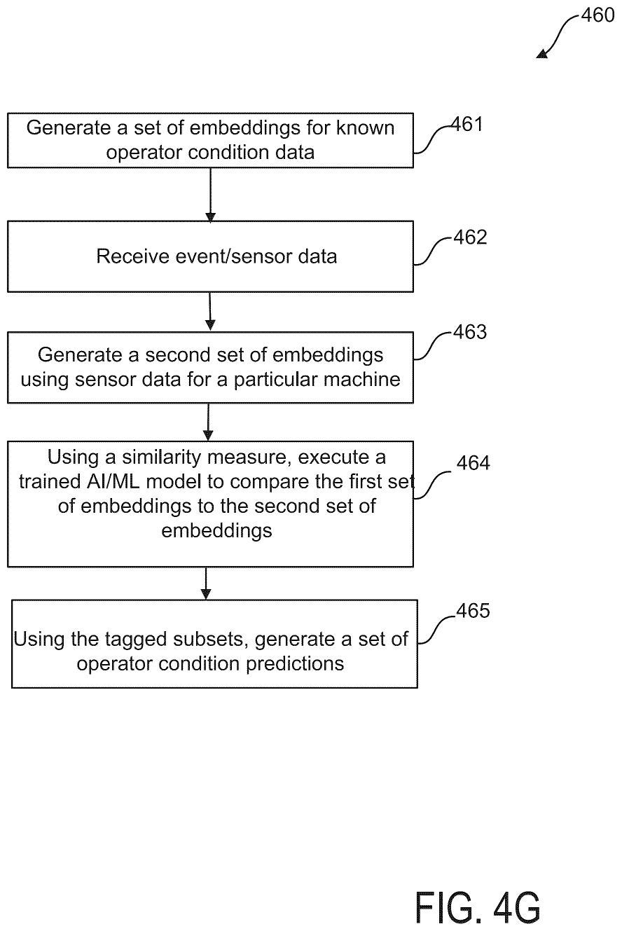

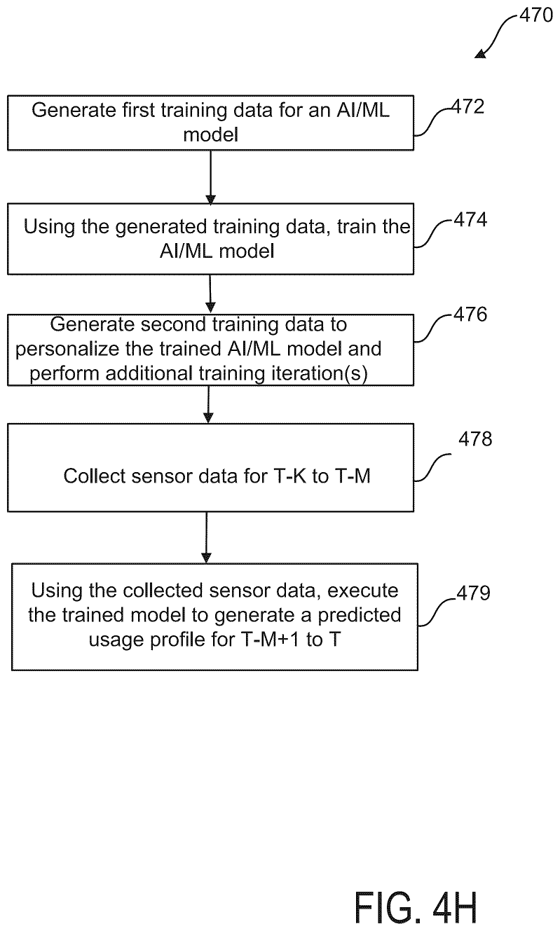

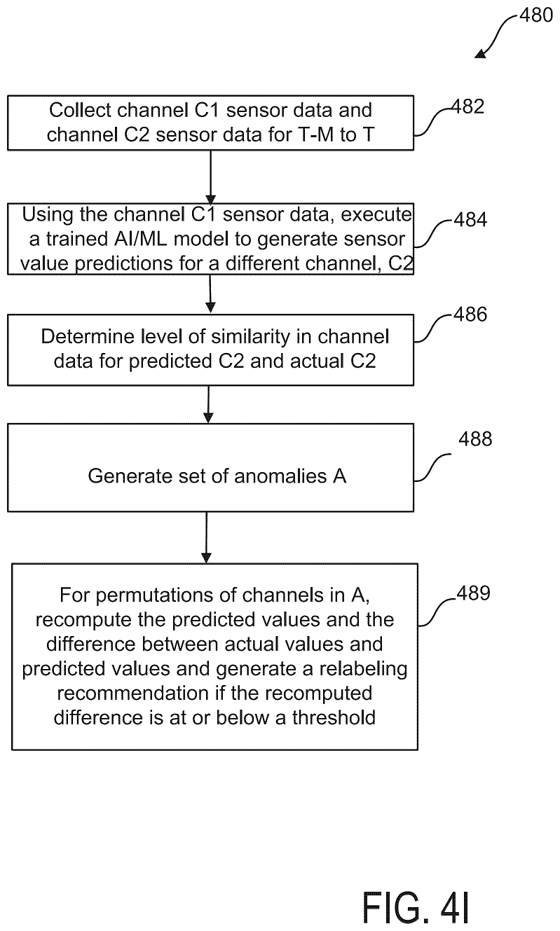

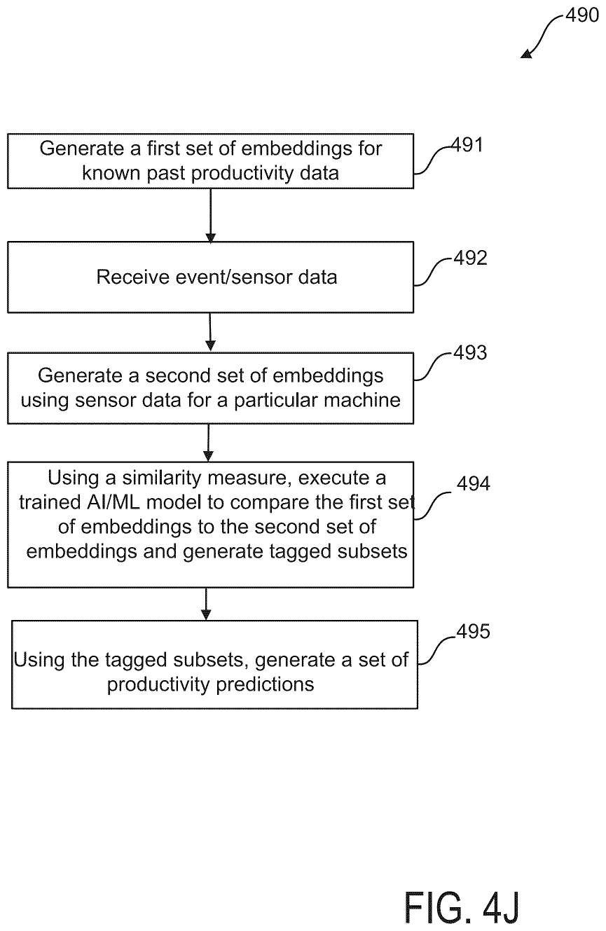

FIG. 2 shows an example asset monitoring system 200, which can be used for AI/ML-augmented asset monitoring and modeling. The asset monitoring system 200 enables various operations described herein, such as current failure identification (FIG. 4A), remaining useful life prediction (FIG. 4B), past service event identification (FIG. 4C), past failure identification (FIG. 4D), past condition identification (FIG. 4E), future service event prediction (FIG. 4F), operator behavior identification (FIG. 4G), usage profile generation (FIG. 4H), automatic channel relabeling (FIG. 4I), and/or asset productivity measurement (FIG. 4J).

In an example, the asset monitoring system 200 can obtain telematics, sensor, and/or supplemental data from assets (102, 104, 108) of FIG. 1A, generate model input features using the data, use the generated features to train AI/ML models to classify, identify, or predict asset-related events, and/or generate recommendations or asset control commands based on the data.

The asset monitoring system 200 can be deployed in a cloud-based or on-premises manner. In some implementations, multiple instances of the asset monitoring system 200 can be deployed in a software-as-a-service (SaaS) mode. Such instances of the asset monitoring system 200 can share various physical and/or virtualized computing resources, such as storage, memory, and/or processors. Additionally or alternatively, in certain arrangements, one or more components of the asset monitoring system 200 can be implemented on-board of the host equipment (e.g., as part of the controllers (102b, 104b, 108b)). Accordingly, operations described herein can be performed, in whole or in part, locally or remotely in relation to the host piece of equipment. Furthermore, the operations described herein can be performed locally or in a distributed, multiple-node fashion with respect to the quantity and geographical location of computer processors utilized to perform the operations.

As shown according to an example of FIG. 2, the asset monitoring system 200 can include a program layer 210, a data layer 220, and an infrastructure layer 240. Together, these layers can form an asset monitoring system 200 stack, which includes particularly configured hardware and software components structured to enable computer-based operations of the asset monitoring system 200.

The program layer 210 can include one or more programs 212. The programs 212 can be structured to perform various tasks that access on-board sensor data and/or use telematics data, for example, in the form of API messages 110b of FIG. 1A. For instance, the programs 212 can be structured to perform asset safety monitoring (e.g., through object detection using various sensor images associated with the asset), bidirectional asset communication, detection of asset operating conditions, monitoring of asset mileage, monitoring of asset fuel consumption, monitoring of weather conditions in a particular asset deployment area, asset wear and tear monitoring, asset load monitoring, asset performance modeling (e.g., via digital twin techniques), monitoring of asset power output, and so forth.

Programs 212 can include on-board executables or circuitry, web-based applications, desktop applications, and/or mobile applications and can enable the asset monitoring system 200 to be accessible from a variety of computing devices, including on-board control panels, on-board computers, desktop computers, smartphones, tablets, diagnostic devices (e.g., on-board diagnostics (OBD) code readers and/or scan tools), and so forth. In various implementations, the programs 212 can be deployed and/or managed by an OEM associated with a particular asset, a customer of the OEM (e.g., a dealer), and/or a third party relative to the OEM and/or the customer of the OEM.

An example program 212 can include control circuitry to coordinate and execute operations described herein. The operations can include generating and updating graphical user interfaces (GUIs) to enable users to perform current failure identification (FIG. 4A), remaining useful life prediction (FIG. 4B), past service event identification (FIG. 4C), past failure identification (FIG. 4D), past condition identification (FIG. 4E), future service event prediction (FIG. 4F), operator behavior identification (FIG. 4G), usage profile generation (FIG. 4H), automatic channel relabeling (FIG. 4I), and/or asset productivity measurement (FIG. 4J). The operations can include, for example, displaying sensor values in data streams/channels, generating and displaying GUIs that include controls to enable users to invoke the above operations, displaying alerts/notifications raised in the course of executing the operations, and/or generating and displaying GUIs that include controls to enable users to act on the alerts/notifications. Enabling users to act on the alerts/notifications can include, for example, generating and displaying GUIs that include controls to enable users to route the alerts/notifications to a user-selected computing system (e.g., dealer, dispatch, sales), enable users to override automatic actions taken in response to the notifications, enable users to select a particular operating mode (e.g., safe operating mode) automatically suggested in response to a notification, and so forth.

The data layer 220 can include various engines and/or data stores that enable data services and/or data access. Generally, various engines at the data layer 220 execute operations that organize, manage, share, compute, and/or enhance various data items stored in the data store(s) 232. The stored items can include telematics data, vector data, embeddings, ontologies, features, outputs, models, and so forth. The engines can include executables that enable data generation, processing, analytics, storage, retrieval, and/or visualization. The data store(s) 232 can be implemented in various suitable forms, such as look-up tables or other data structures encoded in on-board memory units, local file systems, network file systems (NFS), database management systems (DBMS), relational DBMS, database file systems (DBFS), distributed ledgers, vector databases, and so forth. Units of data in the data store(s) 232 can be stored in various forms, such as files (e.g., .xml, .json), database tables, embeddings, and/or distributed ledger blocks. As such, the data store(s) 232 can utilize various data storage techniques, including file storage, object storage, content-addressed storage, vector storage, and/or block storage.

As shown, example engines at the data layer 220 can include a data acquisition engine 222, feature generator engine 224, model training engine 226, model execution engine 228, and/or actuator/recommender engine 230. The data acquisition engine 222 can access or receive telematics or sensor data, as described earlier. In some implementations, the data acquisition engine 222 can include one or more asset controllers and/or can perform data pre-processing operations. The data pre-processing operations can include data normalization, data aggregation, generation of virtual sensor values, imputation of missing values in a sequence of sensor readings, and so forth. In some implementations, the data acquisition engine 222 can further include, at least in part, the interface engine 112.

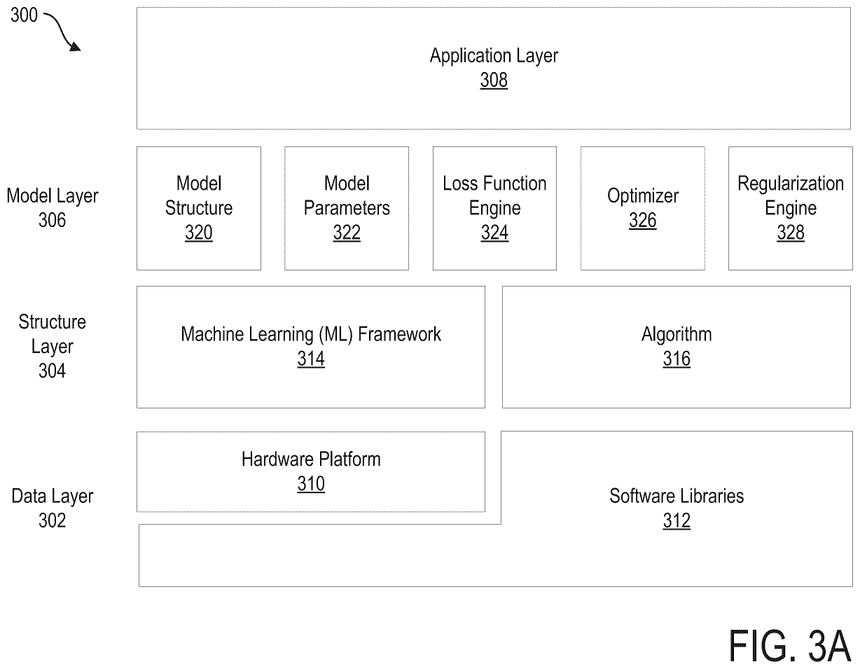

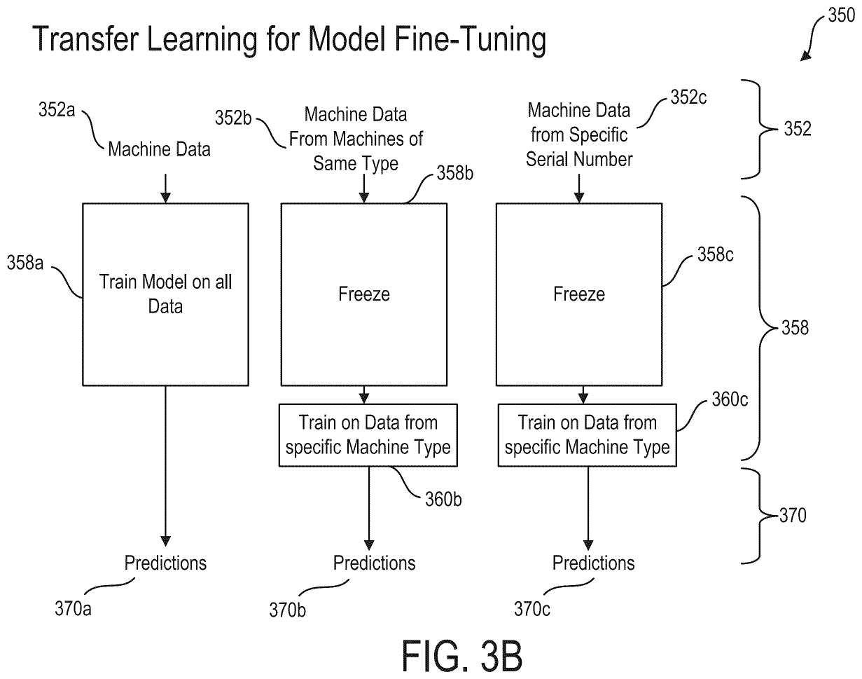

Any or all of the feature generator engine 224, model training engine 226, and/or model execution engine 228 can, in whole or in part, comprise an AI/ML subsystem to classify, identify, or predict asset events, as described in more detail with respect to FIG. 3A.

For instance, the feature generator engine 224 can perform various transformations on raw or pre-processed data received via the data acquisition engine 222. The data transformations can include data optimization operations to improve semantic value of the data. The data optimization operations can include data mapping, identification of ontologies, referencing of ontologies, data consolidation (e.g., generation of entities that combine fault data and productivity/operating condition data), and so forth.

The model training engine 226 can enable further improvements in AI/ML model performance through model training. For example, the models can be trained using the generated features to recognize patterns in the data and automatically classify the data, as described further herein.

The model execution engine 228 can apply (execute) the trained AI/ML models using the features/vectors generated by the feature generator engine 224. The AI/ML models can be trained to perform operations for current failure identification (FIG. 4A), remaining useful life prediction (FIG. 4B), past service event identification (FIG. 4C), past failure identification (FIG. 4D), past condition identification (FIG. 4E), future service event prediction (FIG. 4F), operator behavior identification (FIG. 4G), usage profile generation (FIG. 4H), automatic channel relabeling (FIG. 4I), and/or asset productivity measurement (FIG. 4J). Improved training techniques for the models are described in relation to FIG. 3B.

As shown, FIG. 2 includes an actuator/recommender engine 230. In some implementations, the actuator/recommender engine 230 can generate, based on the output of the model execution engine 228, an electronic instruction and send the electronic instruction to a controller (102b, 104b, 108b) of a particular asset, which can alter or stop operation of the asset (e.g., stop the engine, reduce revolutions-per-minute, place the asset in neutral, forward or reverse, or perform another autonomous operation). In some implementations, the actuator/recommender engine 230 can generate and display, at a computing device (e.g., as part of the program 212) a user interface that can include a recommendation. The recommendation can include one or more recommended actions, as described above.

### AI/ML Subsystem(s) of the Asset Monitoring System

FIG. 3A shows an example implementation of AI/ML subsystems of the asset monitoring system 200. FIG. 3A illustrates a layered architecture of an artificial intelligence (AI) system 300 that can implement the machine learning models of the model execution engine 228 of the asset monitoring system 200, in accordance with some implementations of the present technology. Variants of the AI/ML subsystem can include one or more of the feature generator engine 224, model training engine 226, and/or model execution engine 228. However, these items or components thereof can be omitted, duplicated, or combined, according to various implementations.

According to various implementations, the AI/ML subsystems can include AI/ML models, which can be trained to perform current failure identification (FIG. 4A), remaining useful life prediction (FIG. 4B), past service event identification (FIG. 4C), past failure identification (FIG. 4D), past condition identification (FIG. 4E), future service event prediction (FIG. 4F), operator behavior identification (FIG. 4G), usage profile generation (FIG. 4H), automatic channel relabeling (FIG. 4I), and/or asset productivity measurement (FIG. 4J).

As shown, the AI system 300 can include a set of layers, which conceptually organize elements within an example network topology for the AI system's architecture to implement a particular AI model. Generally, an AI model is a computer-executable program implemented by the AI system 300 that analyzes data to make predictions. Information can pass through each layer of the AI system 300 to generate outputs for the AI model. The layers can include a data layer 302, a structure layer 304, a model layer 306, and an application layer 308. The algorithm 316 of the structure layer 304 and the model structure 320 and model parameters 322 of the model layer 306 together form an example AI model. The optimizer 326, loss function engine 324, and regularization engine 328 work to refine and optimize the AI model, and the data layer 302 provides resources and support for application of the AI model by the application layer 308. The application layer 308 can include, in whole or in part, the model execution engine 228 of the asset monitoring system 200. For example, the model execution engine 228 can provide the feature map or other feature data to one or more trained AI models described herein and can cause (e.g., by executing an instruction set or prompt using the framework 314) the AI model to execute.

The data layer 302 acts as the foundation of the AI system 300 by preparing data for the AI model. As shown, the data layer 302 can include two sub-layers: a hardware platform 310 and one or more software libraries 312. The hardware platform 310 can be designed to perform operations for the AI model and include computing resources for storage, memory, logic and networking. The hardware platform 310 can process amounts of data using one or more servers. The servers can perform backend operations such as matrix calculations, parallel calculations, machine learning (ML) training, and the like. Examples of servers used by the hardware platform 310 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 310 can include Infrastructure as a Service (IaaS) resources, which are computing resources, (e.g., servers, memory, etc.) offered by a cloud services provider. The hardware platform 310 can also include computer memory for storing data about the AI model, application of the AI model, and training data for the AI model. The computer memory can be a form of random-access memory (RAM), such as dynamic RAM, static RAM, and non-volatile RAM. The hardware platform can, in whole or in part, be included in or accessible to the devices of the infrastructure layer 240 of the asset monitoring system 200.

The software libraries 312 can be thought of as suites of data and programming code, including executables, used to control the computing resources of the hardware platform 310. The programming code can include low-level primitives (e.g., fundamental language elements) that form the foundation of one or more low-level programming languages, such that servers of the hardware platform 310 can use the low-level primitives to carry out specific operations. The low-level programming languages do not require much, if any, abstraction from a computing resource's instruction set architecture, allowing them to run quickly with a small memory footprint. Examples of software libraries 312 that can be included in the AI system 300 include Intel Math Kernel Library, Nvidia cuDNN, Eigen, and Open BLAS.

The structure layer 304 can include an ML framework 314 and one or more of an algorithm 316. The ML framework 314 can be thought of as an interface, library, or tool that allows users to build and deploy the AI model. The ML framework 314 can include an open-source library, an application programming interface (API), a gradient-boosting library, an ensemble method, and/or a deep learning toolkit that can work with the layers of the AI system facilitate development of the AI model. For example, the ML framework 314 can distribute processes for application or training of the AI model across multiple resources in the hardware platform 310. The ML framework 314 can also include a set of pre-built components that have the functionality to implement and train the AI model and allow users to use pre-built functions and classes to construct and train the AI model. Thus, the ML framework 314 can be used to facilitate data engineering, development, hyperparameter tuning, testing, and training for the AI model. Examples of ML frameworks 314 that can be used in the AI system 300 include TensorFlow, PyTorch, Scikit-Learn, Keras, Cafffe, LightGBM, Random Forest, and Amazon Web Services.

The algorithm 316 can be an organized set of computer-executable operations used to generate output data from a set of input data and can sometimes be described using pseudocode. The algorithm 316 can include complex code that allows the computing resources to learn from new input data and create new/modified outputs based on what was learned.

The algorithm 316 can build the AI model through being trained (e.g., via the model training engine 226, which can include a user interface having controls sufficient to enable a user to interact with the model, label data, and so forth) while running computing resources of the hardware platform 310. This training allows the algorithm 316 to make predictions or decisions without being explicitly programmed to do so. Once trained, the algorithm 316 can run at the computing resources as part of the AI model to make predictions or decisions, improve computing resource performance, or perform tasks. The algorithm 316 can be trained using supervised learning, unsupervised learning, semi-supervised learning, and/or reinforcement learning.

Using supervised learning, the algorithm 316 can be trained to learn patterns (e.g., map input data to output data) based on labeled training data, which can include items described in relation to FIGS. 1B-1F. The training data may be labeled by an external user or operator. The user may label the training data with identifiers of one or more classes (e.g., monitoring categories, maintenance activity types, repair activity types, maintenance event classifications) and train the AI model by inputting the training data (e.g., via the user interface of the model training engine 226) to the algorithm 316. The algorithm determines how to label the new data, such as items from additional data sets (which can include additional items described in relation to FIGS. 1B-1F and/or data from the data source 130), based on the labeled training data.

The user can facilitate collection, labeling, and/or input via the ML framework 314. In some instances, the user may convert the training data to a set of feature vectors for input to the algorithm 316. For example, the system may vectorize any of the items described, in order to facilitate item comparisons via techniques such as semantic search. Once trained, the user can test the algorithm 316 on new data to determine if the algorithm 316 is predicting accurate labels for the new data. For example, the user can use cross-validation methods to test the accuracy of the algorithm 316 and retrain the algorithm 316 on new training data if the results of the cross-validation are below an accuracy threshold.

Supervised learning can involve classification and/or regression. That is, the algorithm 316 can be a classification-and/or regression-based algorithm. Classification techniques involve teaching the algorithm 316 to identify a category of new observations based on training data and are used when input data for the algorithm 316 is discrete. Said differently, when learning through classification techniques, the algorithm 316 receives training data labeled with categories (e.g., classes) and determines how features observed in the training data relate to the categories. Once trained, the algorithm 316 can categorize new data by analyzing the new data for features that map to the categories, which can be any of the categories described herein, including anomaly (failure mode) descriptors, past event descriptors, service event descriptors, machine condition descriptors, operator condition descriptors, channel descriptors, and/or productivity descriptors. Examples of classification techniques include boosting, decision tree learning, genetic programming, learning vector quantization, k-nearest neighbor (k-NN) algorithm, and statistical classification.

Regression techniques involve estimating relationships between independent and dependent variables and can be used when input data to the algorithm 316 is continuous or time-series. Regression techniques can be used to train the algorithm 316 to predict or forecast relationships between variables. To train the algorithm 316 using regression techniques, a user can select a regression method for estimating the parameters of the model. The user collects and labels training data that is input to the algorithm 316 such that the algorithm 316 is trained to understand the relationship between data features and the dependent variable(s). Once trained, the algorithm 316 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations. In an example, a particular AI/ML model can be an imputer trained to fill in missing data values (e.g., fault codes, productivity metrics, attributes, time units, calculated values, or any other items described in relation to FIGS. 1B-1F).

The model layer 306 can implement the AI model using data from the data layer and the algorithm 316 and ML framework 314 from the structure layer 304, thus enabling decision-making capabilities of the AI system 300. The model layer 306 can include any of a model structure 320, model parameters 322, a loss function engine 324, an optimizer 326, and a regularization engine 328.

The model structure 320 describes the architecture of the AI model of the AI system 300. The model structure 320 defines the complexity of the pattern/relationship that the AI model expresses. Examples of structures that can be used as the model structure 320 include decision trees, support vector machines, regression analyses, Bayesian networks, Gaussian processes, genetic algorithms, and artificial neural networks (or, simply, neural networks). The model structure 320 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 320 may include one or more hidden layers of nodes between the input and output layers. The model structure 320 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 322 represent the relationships learned by a model during training and can be used to make predictions and decisions based on input data. The model parameters 322 can weight and bias the nodes and connections of the model structure 320. For instance, when the model structure 320 is a neural network, the model parameters 322 can weight and bias the nodes in each layer of the neural networks, such that the weights determine the strength of the nodes and the biases determine the thresholds for the activation functions of each node. The model parameters 322, in conjunction with the activation functions of the nodes, determine how input data is transformed into desired outputs. The model parameters 322 can be automatically determined and/or altered during training of the algorithm 316.

The loss function engine 324 can determine a loss function, which is a metric used to evaluate the AI model's performance during training. For instance, the loss function engine 324 can measure the difference between a predicted output of the AI model and the actual output of the AI model and is used to guide optimization of the AI model during training to minimize the loss function. The loss function may be presented via the ML framework 314, such that a user can determine whether to retrain or otherwise alter the algorithm 316 if the loss function is over a threshold. In some instances, the algorithm 316 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 326 adjusts the model parameters 322 to minimize the loss function during training of the algorithm 316. In other words, the optimizer 326 uses the loss function generated by the loss function engine 324 as a guide to determine what model parameters lead to the most accurate AI model. Examples of optimizers include Gradient Descent (GD), Adaptive Gradient AIgorithm (AdaGrad), Adaptive Moment Estimation (Adam), Root Mean Square Propagation (RMSprop), Radial Base Function (RBF) and Limited-memory BFGS (L-BFGS). The type of optimizer 326 used may be determined based on the type of model structure 320 and the size of data and the computing resources available in the data layer 302.

The regularization engine 328 executes regularization operations. Regularization is a technique that prevents over-and under-fitting of the AI model. Overfitting occurs when the algorithm 316 is overly complex and too adapted to the training data, which can result in poor performance of the AI model. Underfitting occurs when the algorithm 316 is unable to recognize even basic patterns from the training data such that it cannot perform well on training data or on validation data. The optimizer 326 can apply one or more regularization techniques to fit the algorithm 316 to the training data properly, which helps constrain the resulting AI model and improves its ability for generalized application. Examples of regularization techniques include lasso (L1) regularization, ridge (L2) regularization, and elastic (L1 and L2 regularization).

The application layer 308 describes how the AI system 300 is used to solve problem or perform tasks. In an example implementation, the application layer 308 can include one or more programs 212. For example, the application layer 308 can include executables and/or user interfaces to classify, identify, or predict items in the use cases of FIGS. 4A-4J using the AI/ML ecosystem of FIG. 3A.

### Iterative AI/ML Model Training Techniques

FIG. 3B shows an example training schema for the ML models of the AI/ML subsystems of the asset monitoring system 200. The training data 352 can include raw, transformed, and/or vectorized values, such as sensor data and/or channel data. The training data 352 can also include labels (classifiers, tags), which can relate to anomaly descriptors, past event descriptors, service event descriptors, machine condition descriptors, operator condition descriptors, channel descriptors, and/or productivity descriptors. In some implementations, the labels further classify these descriptors in relation to specific assets, asset types, channel identifiers and/or sensor serial numbers. The labels can be automatically generated and/or manually generated or updated.

The models are trained, at 358, to generate predictions 370. The training process can include more than one iteration. For example, the ML models can be initially trained on a first training corpus (e.g., as shown at 358a). The ML models can be subsequently retrained (at 360b, 360c) on additional data, such as asset data for specific types and/or serial numbers. The additional data (subsequent training corpi) can include manually-selected values and/or automatically-determined values. For example, when sensor signals indicate new data or patterns in data, these items can be automatically flagged for inclusion in the subsequent training corpi.

### Example Use Cases

FIGS. 4A-4J show aspects of operations for machine-learning based event identification and scenario modeling performed using the asset monitoring system 200 of FIG. 2. A hardware or software processor executing instructions described in this application can perform the operations described herein. One of skill will appreciate that operations can be omitted, combined, and/or substituted without departing from the spirit of the invention.

Example operations can include current failure identification (FIG. 4A), remaining useful life prediction (FIG. 4B), past service event identification (FIG. 4C), past failure identification (FIG. 4D), past condition identification (FIG. 4E), future service event prediction (FIG. 4F), operator behavior identification (FIG. 4G), usage profile generation (FIG. 4H), automatic channel relabeling (FIG. 4I), and/or asset productivity measurement (FIG. 4J). One of skill will appreciate that the teachings presented in various examples can be combined.

Although not expressly described for each example, it is contemplated that the system can generate input features and/or maps for the machine learning models described herein. Generating the input features and/or maps can include any operations described in relation to FIGS. 1B-1F, including aggregations of sensor values within/across channels, imputation of sensor values in sensor value sequences, and/or augmentation of sensor values using labels (e.g., asset serial number, asset type, location, network, and so forth). Furthermore, the models described herein can be trained to personalize model outputs, such that the training techniques described, for example, in relation to FIG. 3B, can be implemented across use cases even if not expressly described in relation to each of the use cases below.

Although not expressly described for each example, it is contemplated that the system can generate notifications and/or alerts using outputs of the computer-based operations of the use cases. The notifications and/or alerts can be routed to variants of the program 212 described in relation to FIG. 2, and the program 212 can include features that enable users/operators to take action (on-board and/or off-board) on the notifications/alerts, including the specific actions described in relation to FIG. 2.

In the examples below, T refers to a current point in time, K refers to a first previous point in time, and M refers to a second previous point in time.

An example use case includes current failure identification (FIG. 4A). Based on data values from time T-K to T-M, the system can generate, at 402, statistically most likely data values from time T-M+1 to T. The values can be generated by a trained model, such as a neural network, large language model, and the like. The model can be trained, for example, on historical data for a particular serial number of the machine, assets of a similar model, and/or assets of a similar type.

The system can compare these statistically most likely data values with actual observed values from T-M+1 to T. If the difference is significant, the system can identify and report an anomaly. For example, the system can generate a set of embeddings (at 404) for the data values during the identified anomalous time period and compare the embeddings to additional embeddings generated (at 406) for data values representing various potential failure modes (component degradation such as wear and tear quantified by a percentage (0.0%-100%), resource degradation such as fuel depletion quantified by the particular percentage, component failure). To do this, the system can, for example, compute the cosine similarity between the embedding vectors. The system can tag the closest embedding as the failure mode corresponding to the anomaly. For example, the system can use the component coordinates of the embeddings for various failure modes to train a machine learning model (e.g., random forest) (at 408) to categorize the failure mode corresponding to a sequence of data values. The system can embed the data values seen during the anomalous time period and apply the trained machine learning model to the embedding to predict the most likely failure mode and its probability.

After a failure is predicted with a probability value that exceeds a predetermined threshold (e.g., a confidence interval value that exceeds 0.8), a notification can be sent (at 409) to a dealer, operator, or customer computing system in order to take service actions, order replacement parts, schedule maintenance bays or technicians for the repair, and so forth. In some implementations, the system can generate a control signal to an on-board controller of the asset so that the asset may be shut down or see its capacity reduced (e.g., reduce engine revolutions-per-minute) to protect the asset. A leasing or financing agency, insurer, warrantor, or other entity may also be notified to ensure appropriate action is taken. In some implementations, a notification can be transmitted to a computing system of a salesperson to generate a sales lead, or such a lead may be generated automatically via a text message, web page message, etc.

An example use case includes remaining useful life prediction (FIG. 4B). Based on data values from time T-K to T, the system can generate, at 412, statistically most likely data values for a specific machine from time T onward using a trained AI/ML model, such as a neural network, large language model, and the like. The model can be trained, for example, on historical data for a particular serial number of the machine, assets of a similar model, and/or assets of a similar type. In some implementations, using a comparatively longer time unit, such as an hour, and aggregated values enables sufficient predictive lead time. The system can slice a predicted data sequence into segments (possibly overlapping)-for example, the system can generate a prediction for the next 30 days with one day (24 hours) per segment.

At 413, the system can generate a set of embeddings that includes the data values for each segment. The system can compare (at 415) the set of embeddings previously generated (at 414) for data sequences that correspond to known instances of failures or major overhauls for the machine or machine type under consideration. The system can tag (label, modify metadata for) sets of embeddings that are statistically similar to the set of embeddings that includes predicted values (e.g., as measured with a cosine similarity technique using a suitable threshold similarity value, such as 0.8 or higher). In some implementations, the system can generate separate tags for similar sets embeddings identified by failure mode or component. If the start of the earliest such sequence is T+R, then the remaining useful life estimate is R.

In some implementations, the system can repeat operations 412-415. For example, the system can use varying randomness parameters for the predictions generated at 412 by varying the number of values (sensor data points) in input feature maps, varying the value of K within a predetermined range (e.g., within a 24-hour window, within a 3-day window, within a 7-day window), including supplemental items, such as additional sensor readings, in the feature data maps, including or excluding imputed values from the feature maps, and/or specifying a certain number of iterations (e.g., 10, 15, 100) to run a simulation on a set of input values. The system can thereby generate a value (at 416) for the remaining useful life predicted each time and report a calculated value as the estimate of the remaining useful life. The calculated value can be an average value of R, a median value of R, a range of R (e.g., 25^{th} to 75^{th} percentile) or another suitable value.

The remaining useful life prediction can be communicated (at 417) to a dealer, operator, or customer in order to take appropriate service actions, order replacement parts, schedule maintenance bays or technicians, and so forth. The machine can be shut down or see its capacity automatically reduced to protect it if the remaining life is at or under a predetermined threshold (e.g., X hours, X days). A leasing or financing agency, insurer, warrantor, or other entity can be notified to ensure appropriate action is taken. The remaining useful life can be communicated to a salesperson to generate a sales lead (e.g., for an overhaul, component replacement, component rebuild), or such a lead may be transmitted directly to the customer. In some use cases, the technique described above can be used to identify levels of degraded performance that represent an economic end of life, such as in cases where increased fuel costs add up to more than the cost of the overhaul after the determined time R.

An example use case includes past service event identification (FIG. 4C). Patterns of sensor readings can correspond to specific maintenance events. Accordingly, the techniques described herein can be used to generate inferences and predictions regarding maintenance events using sensor data streams.

At 421, the system can execute a trained neural network to generate embeddings for sequences of data values (e.g., sequences of sensor values) that correspond to known events where maintenance is performed, such as preventive maintenance or overhauls. The embeddings can include transformed sensor values, imputed values, and so forth. In some implementations, the system can slice a machine's data sequence into segments (possibly overlapping) and generate embeddings for each segment, such as each hour.

The system can receive (at 422) service event data and/or sensor readings for a particular machine. The service event data can be parsed from invoices, maintenance logs, sensor data streams, and so forth. At 423, the system can generate a second set of embeddings for the data values in the segments and compare it to embeddings generated in step 1 for sequences of data values that represent various maintenance tasks (e.g., by computing the cosine similarity between the embedding vectors). The system can tag (at 424) subsets of embeddings from the second set of embeddings where similarity is above a threshold (e.g., 0.8). The tagged segments, for example, can include descriptors for the inferred maintenance task(s) performed during the segment.

In some implementations, the system can use the component coordinates of the embeddings for various maintenance tasks (e.g., embeddings from the first set of embeddings) to train a machine learning model (e.g., random forest or another classifier model) to categorize the maintenance task mode corresponding to a sequence of data values. The system can embed the data values from each segment after receiving actual sensor values and apply the trained machine learning model to identify/tag the most likely maintenance task performed in that segment (if any).

At 425, the system can use the tagged subsets to generate inferences or predictions regarding service events that took place. The service events thus identified can be added to the machine's service history to help plan future service events (e.g., at similar intervals), to identify lack of service violating warranty, lease, or financing terms, etc. They can also be used to estimate the total cost of servicing the machine over all or part of its life.

An example use case includes past failure identification (FIG. 4D). In such use cases, sensor data streams can be utilized to generate predictions of past failure events, and the operations 431-435 can be similar to the operations 421-425 described above. However, the first set of embeddings can correspond to past failure events for a particular machine or machine type rather than to past maintenance events. In such implementations, the system can generate tagged subsets of embeddings that represent sensor values determined to likely correspond to failure events. The automatically-generated tags can include descriptors of particular failure events.

The tagged subsets of sensor values of the use cases of FIG. C and/or FIG. D can be used to generate statistical distributions of time to failure to update maintenance schedules. In some implementations, the tagged subsets can be used to estimate the total cost of ownership for a particular component related to failures. In some implementations, the tagged subsets can be used to serve as ground truth for a mathematical model that correlates the frequency of preventive maintenance tasks, operating behaviors, and so forth to the mean time to failure. Such a model can be used to predict the time until failure under various operating and service conditions. In some implementations, the tagged subsets can be used in an optimization framework, and the costs of preventive maintenance, the value of productivity (as measured by operating behaviors), and failure repairs can serve as inputs in order to design an optimal service and operating policy. In some implementations, the tagged subsets can serve as ground truth for mathematical models that predict failures based on telematics or other equipment data.

An example use case includes past condition identification (FIG. 4E). Patterns of sensor readings can correspond to specific machine or component condition classifications (e.g., operating normally, degraded, highly degraded, failed). Accordingly, the techniques described herein can be used to generate inferences and predictions regarding machine or component conditions using sensor data streams.

At 441, the system can execute a trained neural network to generate embeddings for sequences of data values (e.g., sequences of sensor values) that correspond to known machine or component conditions. The embeddings can include transformed sensor values, imputed values, and so forth. In some implementations, the system can slice a machine's data sequence into segments (possibly overlapping) and generate embeddings for each segment, such as each hour.

The system can receive (at 442) service event data and/or sensor readings for a particular machine. The data can be parsed from sensor data streams. At 443, the system can generate a second set of embeddings for the data values in the segments and compare it to embeddings generated in step 1 for sequences of data values that represent various machine or component condition classifications (e.g., by computing the cosine similarity between the embedding vectors). The system can tag (at 444) subsets of embeddings from the second set of embeddings where similarity is above a threshold (e.g., 0.8). The tagged segments, for example, can include descriptors for the inferred machine or component conditions that likely correspond to a particular segment.

In some implementations, the system can use the component coordinates of the embeddings for various known machine or component conditions (e.g., embeddings from the first set of embeddings) to train a machine learning model (e.g., random forest or another classifier model) to categorize machine or component conditions correspond to a sequence of data values. The system can embed the data values from each segment after receiving actual sensor values and apply the trained machine learning model to identify/tag the most likely machine or component condition for a segment.

At 445, the system can use the tagged subsets to generate inferences or predictions regarding machine or component conditions for a particular machine. The conditions thus identified can be used to identify when service is being done preventively or as a result of a failure. In some implementations, the inferences/predictions can be used to identify premature service trends (e.g. by detecting, for example, that a dealer prematurely replaced a a component at 12,000 hours of use when 99% of failures and degradation occur after 15,000 hours of use). The data can also be used to optimize service policies by trading off projected costs of reduced performance and extended time between services.

An example use case includes future service event prediction (FIG. 4F). Based on data values from time T-K to T, the system can generate, at 452, statistically most likely data values for service events for a specific machine from time T onward using a trained AI/ML model, such as a neural network, large language model, and the like. The model can be trained, for example, on historical data for a particular serial number of the machine, assets of a similar model, and/or assets of a similar type. In some implementations, using a comparatively longer time unit, such as an hour, and aggregated values enables sufficient predictive lead time. The system can slice a predicted data sequence into segments (possibly overlapping)—for example, the system can generate a prediction for the next 30 days with one day (24 hours) per segment.

At 453, the system can generate a set of embeddings for the data values for each segment. The system can compare (at 455) the set of embeddings previously generated (at 454) for data sequences that correspond to known service events for the machine or machine type under consideration.

In some implementations, the system can repeat operations 452-455. For example, the system can use varying randomness parameters for the predictions generated at 452 by varying the number of values (sensor data points) in input feature maps, varying the value of K within a predetermined range (e.g., within a 24-hour window, within a 3-day window, within a 7-day window), including supplemental items, such as additional sensor readings, in the feature data maps, including or excluding imputed values from the feature maps, and/or specifying a certain number of iterations (e.g., 10, 15, 100) to run a simulation on a set of input values.

The system can augment the generated predictions by generating (at 456) a set of time-point projections for the predictions, using the value of T. For example, the system can compute additional values to associate the relevant likely service events with the time of the start of the corresponding event in a sequence and the type of the service event, and/or with the sequence number for an occurrence of a particular type of service event. An example is a fourth oil change for an asset, which is projected to occur at 3000 hours. Advantageously, such predictions are personalized to a particular asset and reflect both service behavior and machine condition.

The system can thereby generate (at 457) a projected service event indicator, which can include, for example, a projected time and an event description. The projected time can be determined by taking an average value of time-point predictions generated at 456, a median value of time-point predictions, a range of time-point predictions (e.g., 25^{th} to 75^{th} percentile) or another suitable value.

The prediction can be communicated (at 458) via an alert, notification, or the like to a dealer, operator, or customer in order to take appropriate service actions.

In some implementations, the use case of FIG. 4F can be combined with the past service event identification use case of FIG. 4C to correlate preventive service events with future service event timings in order to optimize service timings. For example, the system can utilize maintenance cost data to generate maintenance and overhaul cost predictions. As an example, the system can be used to determine that yearly predictive maintenance activities for $X per year extend the time to a $Y overhaul by K years. This information can be included in the alert/notification generated at 458.

An example use case includes operator behavior identification (FIG. 4G). Patterns of sensor readings can be indicative of operator behavior or operator condition, such as operating normally, fatigued, asleep, under the influence, suffering a heart attack, untrained, operating recklessly). Accordingly, the techniques described herein can be used to generate inferences and predictions regarding operator behavior or operator condition using sensor data streams.

At 461, the system can execute a trained neural network to generate embeddings for sequences of data values (e.g., sequences of sensor values) that correspond to known operator conditions. The embeddings can include transformed sensor values, imputed values, and so forth. In some implementations, the system can slice a machine's data sequence into segments (possibly overlapping) and generate embeddings for each segment, such as each hour.

The system can receive (at 462) sensor readings for a particular machine. At 463, the system can generate a second set of embeddings for the data values in the segments and compare it to embeddings generated in step 1 for sequences of data values that represent various operator behaviors or operator conditions (e.g., by computing the cosine similarity between the embedding vectors). The system can tag (at 464) subsets of embeddings from the second set of embeddings where similarity is above a threshold (e.g., 0.8). The tagged segments, for example, can include descriptors for the inferred operator behavior or operator condition for a particular segment.

In some implementations, the system can use the component coordinates of the embeddings for various maintenance tasks (e.g., embeddings from the first set of embeddings) to train a machine learning model (e.g., random forest or another classifier model) to categorize the operator behaviors or operator conditions corresponding to a sequence of data values. The system can embed the data values from each segment after receiving actual sensor values and apply the trained machine learning model to identify/tag the most likely operator behavior or operator condition for the segment.

At 465, the system can use the tagged subsets to generate inferences or predictions regarding operator behaviors or operator conditions. The operator behaviors or operator conditions thus identified may be used to identify dangerous operating conditions, when an operator is not properly trained, when an operator is using the equipment improperly, and so forth. For example, if the control inputs consistently exhibit a reversing or oscillating behavior, as if a target bucket position is overshot or difficult to achieve, the operator may be fatigued. As another use, the results of this use case may be used during accident reconstruction to identify whether operator error can be a cause of the accident. As another application, the results of this use case may be used to enforce training or safety requirements, such as those of insurers, lessors, or lenders.

An example use case includes usage profile generation (FIG. 4H). A usage profile prediction for a particular machine can be generated using a base trained model, which can be further personalized with relevant training data as described, for example, in relation to FIG. 3B. At 472, the system can generate first training data, which can be used to train (at 474) a base version of a classifier, neural network, large language model, or another suitable model. At 476, the system can generate second training data, which can include, for example historical data for a particular serial number, asset type, location, job type, or a combination thereof. The second training data can be used, at 476, to iteratively train the model. At 479, based on data values from time T-K to T-M, the trained model can be executed on input sensor data, collected at 478, to generate statistically most likely data values from time T-M+1 to T. For example, the trained model can generate a predicted usage profile for a particular machine. The predicted usage profile can include predictions for a day's worth (24 hours) of predicted operation for the machine. A particular predicted usage profile can relate to machine or attachment utilization (e.g., travel, digging, drilling, idle) and can include, for example, a utilization descriptor and a projected utilization percentage or percentage range (e.g., based on confidence intervals). Predicted usage profiles can also include predictions for operating modes (e.g., for gensets), such as normal mode, safe mode, reduced-capacity mode, and so forth. Predicted usage profiles can also include predictions for utilization levels of components, such as cylinder deactivation patterns for multi-cylinder engines.

In some implementations, the predicted usage profile can be used in product development to drive simulations to test the performance of new product configurations, to serve as control inputs to physics-based digital twin models, and so forth. For example, the predicted usage profile can be utilized to run simulations or change parameters to answer queries, such as “If we increase horsepower to the engine by X %, what is the expected effect on [variable Y]?”

In an example, if the predicted usage profile includes predicted values for fuel burn or battery charge, these predicted values can be used to predict time to next refueling or battery charge remaining (in hours) under the usage profile. The predictions can be fed into an algorithm to optimally schedule recharge of the machine, refueling of the machine, and so forth. In an example, the predicted usage profile can be used to predict (for instance, with fuel burn converted to electrical energy demands) the average number of battery charges projected per day (e.g., to help inform product development decisions). In another example, the predicted usage profile can feed into a battery life prediction algorithm or physics-based simulation to predict battery degradation and the time until the battery needs to be replaced.

An example use case includes automatic channel relabeling (FIG. 4I). Sometimes channels (i.e. concurrent time series that supply sensor data) are inadvertently mislabeled during configurations. For example, channel C1 can be configured to report sensor values for oil pressure, where channel C2 should be configured to report these values. The techniques described herein enable AI/ML-assisted, automatic channel relabeling.

In an example, at 482, the system can collect a first set of sensor data for channel C1 and a second set of sensor data for channel C2. The sensor data sets can be augmented by, for example, including aggregations, imputed values, synthetic values, or the like. At 484, the system can execute a trained model (e.g., classifier, neural network, large language model) to generate sensor value predictions for channel C2 using data from channel C1. For example, the model may have been previously trained on sets of data for channels C1 and C2, such the model may be able to predict one set of sensor values using another set of sensor values. At 486, the predicted sensor values for channel C2 can be compared to actual sensor values for channel C2. In some implementations, the system can generate and compare embeddings (e.g., using a measure of semantic similarity). In some implementations, the system can compare actual values. At 488, if the similarity level is under a predetermined threshold (e.g., 0.5), the system can generate an anomaly alert. The system can create a set of anomalies A and associate channels C1 and C2 with the set A. The system can further include data from additional channels. At 489, the system can generate permutations of channels in the set A and recompute the difference between the permuted actual values and predicted values. If a permutation P is found where this difference is below a given threshold (e.g., 0.2), the system can generate an inference that a channel associated with the permutation (say, C3) is reporting data that should be reported at C2. The system can generate automatic relabeling recommendations or automatically update channel configuration information, channel metadata, and/or other relevant channel descriptors.

An example use case includes asset productivity measurement (FIG. 4J). The system can generate (at 491) a first set of embeddings of data values from sensor streams, where the data values corresponding to known machine or attachment operations (e.g. a full scoop from an excavator, pushing n tons of dirt at s miles per hour). At 492, the system can receive sensor data from a particular machine. At 493, the system can generate a set of embeddings the sensor data values for a time period of interest (e.g., one hour, 24 hours). At 494, the system can execute a trained model to compare the sets of embeddings (e.g., by computing the cosine similarity between the embedding vectors.) The system can generate tagged subsets of embeddings. The operations at 491-494 can be repeated for various time offsets to ensure alignment of operating cycles. For example, if the original time, as indicated by the sensor data or the second set of embeddings, started in mid-scoop, the system can repeat the process by generating (at 492), requesting or receiving a new set of sensor data for a different time window that aligns with the beginning of a particular operating cycle. In some implementations, the operations at 491-494 can be repeated to to tag the data or embeddings with descriptors of the actions performed over a longer time period, summing up the operations performed as a measure of productivity. At 495, the system can generate productivity predictions. In some implementations, the system can scale productivity by some measure of resource consumption (e.g., 50 scoops/operating cycles per gallon of diesel). This metric may be applied as a measure of resource degradation to help schedule maintenance. For example, if it takes 50% more fuel per scoop for the last 10 cycles in a sequence relative to the first 10 cycles in the sequence, the system can compute a rebuild will pay for itself in N months. In some implementations, the system can assign value (e.g., monetary value, resource degradation value) to each operation performed (as indicated by the second set of embeddings or the generated tagged subset) to measure the value of the productivity and/or the price to charge for it.

### Example Computer Systems and Networks

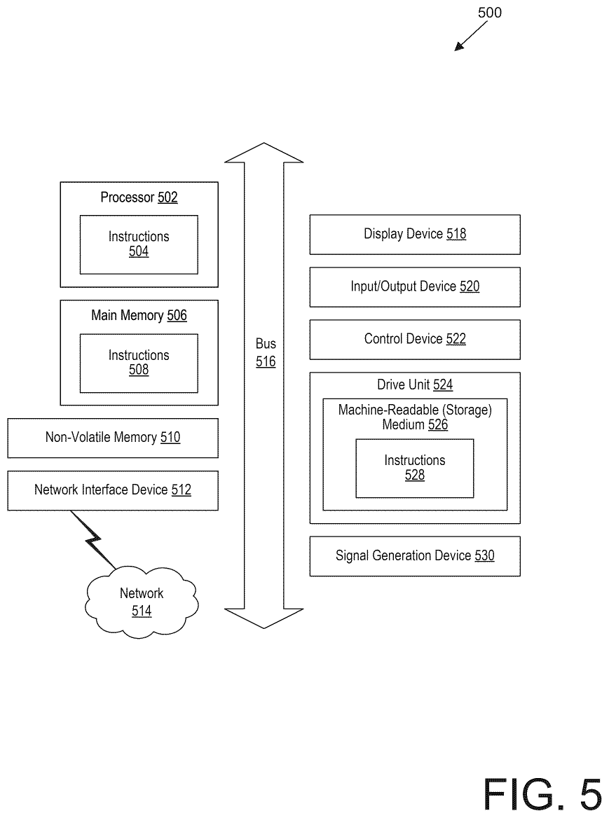

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the Figures and any other components described in this specification can be implemented.

The computer system 500 can take any suitable physical form. For example, the computer system 500 can share a similar architecture as that of a server computer, personal computer (PC), tablet computer, mobile telephone, game console, music player, wearable electronic device, network-connected (“smart”) device (e.g., a television or home assistant device), augmented reality/virtual reality (AR/VR) systems (e.g., head-mounted display), or any electronic device capable of executing a set of instructions that specify action(s) to be taken by the computer system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computer system 500 to mediate data in a network 514 with an entity that is external to the computer system 500 through any communication protocol supported by the computer system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computer system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computer system 500 to perform operations to execute elements involving the various aspects of the disclosure.

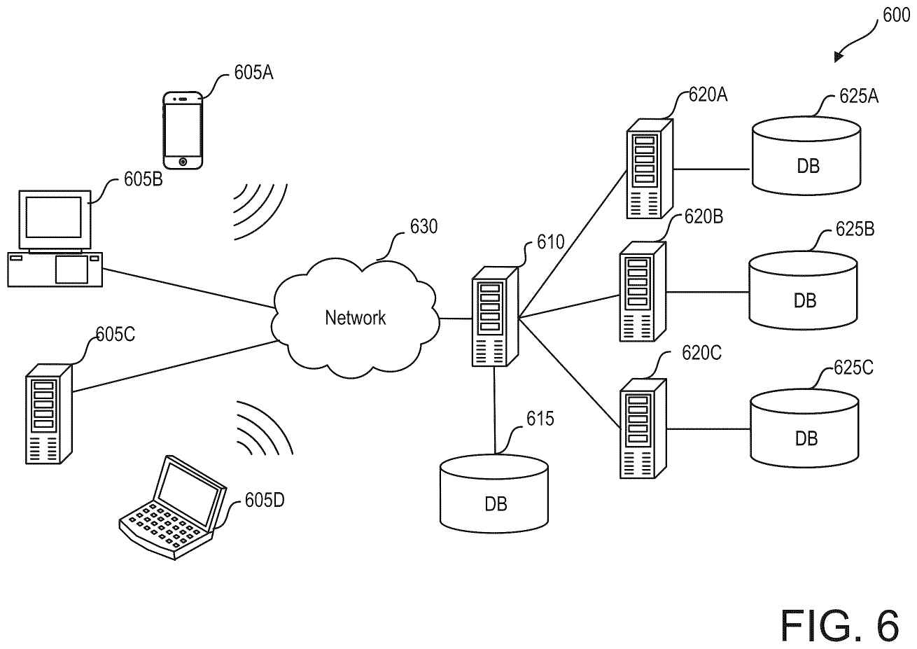

FIG. 6 is a system diagram illustrating an example of a computing environment in which the disclosed platform operates in some implementations. In some implementations, environment 600 includes one or more client computing devices 605A-D, examples of which can host systems described herein. Client computing devices 605 operate in a networked environment using logical connections through network 630 to one or more remote computers, such as a server computing device.

In some implementations, server 610 is an edge server which receives client requests and coordinates fulfillment of those requests through other servers, such as servers 620A-C. In some implementations, server computing devices 610 and 620 comprise computing systems, such as the target computing system 120 of FIG. 1A, the system 200 of FIG. 2, and so forth. Though each server computing device 610 and 620 is displayed logically as a single server, server computing devices can each be a distributed computing environment encompassing multiple computing devices located at the same or at geographically disparate physical locations. In some implementations, each server 620 corresponds to a group of servers.

Client computing devices 605 and server computing devices 610 and 620 can each act as a server or client to other server or client devices. In some implementations, servers (610, 620A-C) connect to a corresponding database (615, 625A-C). As discussed above, each server 620 can correspond to a group of servers, and each of these servers can share a database or can have its own database. Databases 615 and 625 warehouse (e.g., store) information such as telematics data, vector data, embeddings, ontologies, features, outputs, models and so forth. Though databases 615 and 625 are displayed logically as single units, databases 615 and 625 can each be a distributed computing environment encompassing multiple computing devices, can be located within their corresponding server, or can be located at the same or at geographically disparate physical locations.

Network 630 can be a local area network (LAN) or a wide area network (WAN), but can also be other wired or wireless networks. In some implementations, network 630 is the Internet or some other public or private network. Client computing devices 605 are connected to network 630 through a network interface, such as by wired or wireless communication. While the connections between server 610 and servers 620 are shown as separate connections, these connections can be any kind of local, wide area, wired, or wireless network, including network 630 or a separate public or private network.

### INDUSTRIAL APPLICABILITY

Systems, methods and computer-readable media are disclosed herein for ML-assisted event prediction for industrial machines. A first set of embeddings can be generated based on labeled first event data, which can be labeled with classifiers determined based on signaling channel information for the first event data. A neural network can be trained, using the classifiers, to generate (i) a similarity score for the first set of embeddings and the second set of embeddings and (ii) a classifier recommendation for the second set of embeddings. The second set of embeddings can be generated based on data collected using condition monitoring sensors for a particular industrial machine. Accordingly, the system can generate alerts, recommendations, and/or notifications based on the automatically classified data encoded in the second set of embeddings. Incremental training techniques are disclosed for further training the neural network to minimize false positives and/or false negatives.

In some implementations, sensor data for an industrial machine can be modified by generating imputed values. A trained neural network can be executed on the modified sensor data to generate classifier tags for the modified sensor data. The system can generate a binding between the sensor data and the classifier, and generate a notification based on the classifier. The notification can relate to or include a predicted failure, anomaly, usage profile, or remaining useful life estimate for the industrial machine. The system can also generate additional training data to improve predictive capacity of the trained neural network. The additional training data can include additional classifiers determined using sensor signaling channel information or sensor data (e.g., using payload values from sensor signals, metadata values from sensor signals, or metadata associated with a particular sensor signaling channel).

In some implementations, the systems, methods and computer-readable media disclosed herein enable machine-learning (ML)-assisted failover and relabeling of sensor signaling channels for industrial machines. A trained neural network can be selectively engaged to generate a set of sensor value predictions for a particular signaling channel using sensor values from another signaling channel (e.g., when the particular signaling channel is down). Using the predicted values, the system can automatically identify and raise alerts regarding machine operating conditions. A first training dataset, used to initially train the neural network, can relate to a set of condition monitoring sensors on a machine and can include a set of input values associatively linked to signaling channel identifiers and/or channel metadata. A second training dataset, generated if a similarity measure between predicted and actual values is under a predetermined threshold, can be used to incrementally retrain the neural network. Channel metadata can be modified (e.g., for retraining the neural network) to indicate channels suitable for generating substitute predicted signals for a particular channel.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A system for machine-learning (ML)-assisted event prediction for industrial machines, the system comprising:
a set of condition monitoring sensors for an industrial machine;
at least one processor;
at least one memory; and
one or more non-transitory, computer-readable storage media storing instructions, which, when executed by the at least one processor, cause the system to:
using the set of condition monitoring sensors, acquire first sensor data for the industrial machine;
modify the first sensor data by generating a set of imputed sensor values;
using the modified first sensor data, generate a first set of embeddings;
using labeled second sensor data, generate a second set of embeddings, wherein the labeled second sensor data relates to a particular event or condition of industrial machines;
execute a trained neural network on the first set of embeddings and the second set of embeddings to generate a classifier tag for the first set of embeddings, wherein the trained neural network is trained using training data comprising classifiers that relate to labels in the labeled second sensor data;
using the classifier tag, generate a binding between the first set of embeddings and the classifier; and
generate a notification that relates to the classifier.

2. The system of claim 1, wherein the instructions further cause the system to further train the neural network by performing operations to:
determine, using the first sensor data or the modified first sensor data, an additional classifier that relates to a combination of (i) at least one of a machine type and a machine serial number and (ii) the particular event or condition;
generate additional training data using the first sensor data, the additional training data comprising the additional classifier; and
further train the neural network using the additional training data.

3. The system of claim 2, wherein the additional classifier is determined using sensor signaling channel information associated with the first sensor data.

4. The system of claim 2, wherein at least one of the classifier tag or the additional classifier relates to a particular failure mode of the industrial machine.

5. The system of claim 1, wherein the instructions further cause the system to generate a remaining useful life estimate for the industrial machine using the modified first sensor data and an additional set of predicted sensor data generated using the modified first sensor data.

6. The system of claim 5, wherein the instructions further cause the system to generate a predicted usage profile for the industrial machine using the modified first sensor data.

7. The system of claim 1, wherein the instructions further cause the system to:
cause a computing device to display the notification, wherein the computing device comprises at least one of an on-board computing system, an on-board navigation system, or a mobile computing device communicatively coupled to the industrial machine.

8. One or more non-transitory, computer-readable storage media storing instructions, which, when executed by at least one processor, cause a system to:
using the set of condition monitoring sensors, acquire first sensor data for the industrial machine;
modify the first sensor data by generating a set of imputed sensor values;
using the modified first sensor data, generate a first set of embeddings;
using labeled second sensor data, generate a second set of embeddings, wherein the labeled second sensor data relates to a particular event or condition of industrial machines;
execute a trained neural network on the first set of embeddings and the second set of embeddings to generate a classifier tag for the first set of embeddings, wherein the trained neural network is trained using training data comprising classifiers that relate to labels in the labeled second sensor data;
using the classifier tag, generate a binding between the first set of embeddings and the classifier; and
generate a notification that relates to the classifier.

9. The media of claim 8, wherein the instructions further cause the system to further train the neural network by performing operations to:
determine, using the first sensor data or the modified first sensor data, an additional classifier that relates to a combination of (i) at least one of a machine type and a machine serial number and (ii) the particular event or condition;
generate additional training data using the first sensor data, the additional training data comprising the additional classifier; and
further train the neural network using the additional training data.

10. The media of claim 9, wherein the additional classifier is determined using sensor signaling channel information associated with the first sensor data.

11. The media of claim 9, wherein at least one of the classifier tag or the additional classifier relates to a particular failure mode of the industrial machine.

12. The media of claim 8, wherein the instructions further cause the system to generate a remaining useful life estimate for the industrial machine using the modified first sensor data and an additional set of predicted sensor data generated using the modified first sensor data.

13. The media of claim 12, wherein the instructions further cause the system to generate a predicted usage profile for the industrial machine using the modified first sensor data.

14. The media of claim 8, wherein the instructions further cause the system to:
cause a computing device to display the notification, wherein the computing device comprises at least one of an on-board computing system, an on-board navigation system, or a mobile computing device communicatively coupled to the industrial machine.

15. A computer-implemented method for machine-learning (ML)-assisted event prediction for industrial machines, the method comprising:
using a set of condition monitoring sensors, acquiring first sensor data for an industrial machine;
modifying the first sensor data by generating a set of imputed sensor values;
using the modified first sensor data, generating a first set of embeddings;
using labeled second sensor data, generating a second set of embeddings, wherein the labeled second sensor data relates to a particular event or condition of industrial machines;
executing a trained neural network on the first set of embeddings and the second set of embeddings to generate a classifier tag for the first set of embeddings, wherein the trained neural network is trained using training data comprising classifiers that relate to labels in the labeled second sensor data;
using the classifier tag, generating a binding between the first set of embeddings and the classifier; and
generating a notification that relates to the classifier.

16. The method of claim 15, further comprising:
determining, using the first sensor data or the modified first sensor data, an additional classifier that relates to a combination of (i) at least one of a machine type and a machine serial number and (ii) the particular event or condition;
generating additional training data using the first sensor data, the additional training data comprising the additional classifier; and
further training the neural network using the additional training data.

17. The method of claim 16, wherein the additional classifier is determined using sensor signaling channel information associated with the first sensor data.

18. The method of claim 16, wherein at least one of the classifier tag or the additional classifier relates to a particular failure mode of the industrial machine.

19. The method of claim 15, further comprising generating a remaining useful life estimate for the industrial machine using the modified first sensor data and an additional set of predicted sensor data generated using the modified first sensor data.

20. The method of claim 19, further comprising generating a predicted usage profile for the industrial machine using the modified first sensor data.
